(19) United States
(12) Patent Application Publication
(10) Pub. No.: US 2026/0085228 A1
(43) Pub. Date: Mar. 26, 2026

(54) LOST-CIRCULATION COMPOSITION, LOST-CIRCULATION MATERIAL AND USE THEREOF

(71) Applicants: CHINA PETROLEUM & CHEMICAL CORPORATION, Beijing (CN); SINOPEC PETROLEUM ENGINEERING TECHNOLOGY RESEARCH INSTITUTE CO., LTD, Beijing (CN)

(72) Inventors: Daqi LI, Beijing (CN); Fan LI, Beijing (CN); Jinhua LIU, Beijing (CN); Junbin JIN, Beijing (CN); Zengwei CHEN, Beijing (CN); Bitao SONG, Beijing (CN); Dujie ZHANG, Beijing (CN); Fengying ZHANG, Beijing (CN)

(21) Appl. No.: 19/108,859

(22) PCT Filed: Aug. 24, 2023
(86) PCT No.: PCT/CN2023/114609

§ 371 Date: Mar. 5, 2025

(30) Foreign Application Priority Data
Sep. 6, 2022 (CN) 202211082409.3
Sep. 6, 2022 (CN) 202211082422.9
Sep. 6, 2022 (CN) 202211082427.1

(51) Int. Cl. C09K 8/512; C09K 8/42; C09K 8/44; C09K 8/467

(52) U.S. Cl. CPC C09K 8/512; C09K 8/426; C09K 8/44; C09K 8/467

(57) ABSTRACT

A lost-circulation composition for oil drilling operations can be cross-linked to form a gel before or during being injected into the formation, and the gel can be cured at the lost-circulation formation to form a lost-circulation material. The mass retention rate of the gel when scouring at 50-180° C. for 30 min at a water flow rate of 10 m/min is 90% or more. The lap anti-shear strength of the lost-circulation material is 0.1-0.14 MPa. The lost-circulation composition of the present invention is suitable for a water-bearing formation having a temperature of not higher than 180° C., especially a flowing water-bearing formation. The lost-circulation composition can be cross-linked to form a gel, and after being injected into the water-containing formation, the gel can realize strong retention around a wellbore, and can be cured under formation conditions to form a lost-circulation material, which finally blocks the lost-circulation formation.

### CROSS-REFERENCE TO RELATED APPLICATIONS

The present application claims the benefit of the Chinese patent application numbers “202211082422.9”, “202211082409.3” and “202211082427.1”, filed on Sep. 6, 2022, the contents of which are specifically and entirely incorporated herein by reference.

### TECHNICAL FIELD

The invention relates to the technical field of oil drilling, in particular to a lost-circulation composition, a lost-circulation material, and a use thereof.

### BACKGROUND ART

The water-bearing lost circulation formation is generally communicated with an underground river, the underground water is very active, and the generated lost circulation has a fast lost circulation rate and a large lost circulation amount, thus it is difficult to deal with the water-bearing lost circulation formation. In terms of plugging the water-bearing lost circulation formation, there is not the particularly desirable solution at present, the main reason may be that the lost circulation slurry is easily diluted or displaced along with the water flow, the direct results are as follows: (1) the viscosity of the lost circulation slurry is reduced by scouring and diluting, the concentration of the lost circulation material is decreased, the lost circulation material is apt to flow away under the action of pressure, and the lost circulation material can hardly be retained and accumulated near an inlet of the lost-circulation formation; (2) for the consolidation and lost circulation slurry, the lost circulation slurry can hardly be coagulated and cured after being diluted, or the setting strength is greatly reduced, the slurry cannot withstand the destructive effect of mud, so that the plugging operation fails; (3) if the formation water is a flowing water, the lost circulation slurry will be quickly taken away by the formation water under the action of the water flow, so that a plugging wall cannot be formed, it causes failure of the plugging operation. The plugging of the water-bearing formation, especially a flowing water-bearing formation, has not been well solved.

CN111849437A relates to the field of oil drilling and discloses a pretreating agent for lost circulation of water-bearing formation, a preparation method, and a use thereof. The pretreating agent for lost circulation of water-bearing formation comprises the following components in parts by weight: 100 parts of water-soluble phenolic aldehyde, 0.1-10 parts of a water-soluble phenolic aldehyde emulsifier and 10-400 parts of water. However, the pretreating agent only forms a substance with high adhesion and a strong wall-hanging property in a water-bearing layer, the substance can be easily washed away by water when it is applied in a flowing water-bearing formation.

For the sake of solving the aforementioned defects, it is urgently necessary to develop a lost-circulation composition suitable for a flowing water-bearing formation, which exhibits excellent properties in aspects such as water dilution resistance, strong retention, high-temperature resistance, and compressive strength.

### SUMMARY OF THE INVENTION

The invention aims to overcome the defects in the prior art concerning the poor performance of the lost-circulation composition in terms of water dilution resistance, high-temperature resistance, and compressive strength, and provides a lost-circulation composition, a lost-circulation material and a use thereof, wherein the lost-circulation composition is suitable for the use in a flowing water-bearing formation.

In order to fulfill the above purpose, the first aspect of the present invention provides a lost-circulation composition, the lost-circulation composition can be cross-linked to form a gel before or during being injected into the formation, and the gel can be cured at the lost-circulation formation to form a lost-circulation material, wherein the mass retention rate of the gel when scouring at 50-180° C. for 30 min at a water flow rate of 10 m/min is 90% or more; and the lap anti-shear strength of the lost-circulation material is within the range of 0.1-0.14 MPa.

The second aspect of the present invention provides a lost-circulation material obtained by curing the aforementioned lost-circulation composition.

The third aspect of the present invention provides a use of the aforementioned lost-circulation composition or the aforesaid lost-circulation material in plugging the oil well formation; the oil well formation is preferably a flowing water-bearing oil well formation with a temperature range of 50-180° C.

The fourth aspect of the present invention provides a method of plugging an oil well, the method comprises: injecting the aforementioned lost-circulation composition directly into cracks in the oil well formation such that the lost-circulation composition forms a gel during the process of injection into the formation, or injecting a gel into cracks in the oil well formation after the aforesaid lost-circulation composition forms the gel, which is cured at the lost-circulation formation under the formation conditions to form a lost-circulation material; wherein the mass retention rate of the gel when scouring at 50-180° C. for 30 min at a water flow rate of 10 m/min is 90% or more; and the lap anti-shear strength of the lost-circulation material is within the range of 0.1-0.14 MPa.

A use of the aforementioned lost-circulation composition or the aforesaid lost-circulation material in the process of loss circulation of a flowing water-bearing formation; especially the use during the process of lost circulation of the flowing water-bearing formation with a temperature range of 50-180° C.

Due to the aforementioned technical scheme, the invention produces the favorable technical effects as follows:

(1) The lost-circulation composition of the invention can be cross-linked to form a gel before or during being injected into the formation, and the gel can be cured at the lost-circulation formation to form a lost-circulation material, wherein the mass retention rate of the gel when scouring at 50-180° C. for 30 min at a water flow rate of 10 m/min is 90% or more; after injection into the water-bearing formation, the lost-circulation composition after being injected into the water-bearing formation, the gel can realize strong retention around a wellbore, and can be cured under formation conditions to form a lost-circulation material having a lap anti-shear strength within the range of 0.1-0.14 MPa and compressive strength not less than 16 MPa, which finally plugs the lost-circulation formation.

(2) The cross-linkable polymer in the lost-circulation composition of the invention initially carries out a cross-linking reaction with a cross-linking agent to generate a gel, which encapsulates other ingredients in a network structure formed by the cross-linking process, such that the system will not be scattered by water, the mass retention rate of the gel when scouring for 30 min at a water flow rate of 10 m/min is 90% or more, and the bearing strength can reach 7 MPa.

(3) Compared with the existing lost-circulation composition, the lost-circulation material of the invention has remarkable improvements in water dilution resistance, high-temperature resistance, and the like, and can be suitable for the plugging of a water-bearing formation, particularly the plugging of a flowing water-bearing formation with a temperature range of 50-180° C.

### DESCRIPTION OF THE PREFERRED EMBODIMENT

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed to have been specifically disclosed herein.

The first aspect of the invention provides a lost-circulation composition, the lost-circulation composition can be cross-linked to form a gel before or during being injected into the formation, and the gel can be cured at the lost-circulation formation to form a lost-circulation material, wherein the mass retention rate of the gel when scouring at 50-180° C. for 30 min at a water flow rate of 10 m/min is 90% or more, and the lap anti-shear strength of the lost-circulation material is within the range of 0.1-0.14 MPa.

In the invention, the consistency of a system is tested by using a pressurizing densifier OWC-9380B, the test conditions comprise the temperature within the range of 100-180° C., and the pressure within the range of 20-100 MPa; the consistency of the lost-circulation composition is less than 20 BC; when the consistency is within the range of 30-40 BC, the system is in a gel state; when the consistency is more than 70 BC, it is completely cured to form a lost-circulation material.

In the invention, when the testing temperature is below 100° C., the gelling stage and the completely cured stage can also be determined by viscosity value, the apparatus used for viscosity measurement is a Brookfield viscometer DV-2, the rotor is a No. 61-65 rotor, and the rotating speed is 1,000S⁻¹. After mixing the lost-circulation composition, placing the mixture in the set temperature environment (for example, the temperature corresponding to the formation), measuring the viscosity with a viscosimeter once at a time interval, denoting the time point when the viscosity value rises as the gel formation time, and then continuously measuring the viscosity, when the viscosity value is stable and does not rise anymore, that is, the time point when the gel reaches the completely cured state is recorded as the completely cured time.

In the present invention, the mass retention rate of the gel when scouring for 30 min at a water flow rate of 10 m/min is 90% or more, for example, 91%, 92%, 93%, 94%, 95%, 96%, 97%, 98%, and any value within a range consisting of any two numerical values, preferably within the range of 93-97%. The lap anti-shear strength of the lost-circulation material is within the range of 0.1-0.14 MPa, such as 0.1 MPa, 0.11 MPa, 0.12 MPa, 0.13 MPa, 0.14 MPa, and any value within a range consisting of any two numerical values.

In the invention, the lap anti-shear strength of the lost-circulation material refers to the lap anti-shear strength of the interface between the lost-circulation material and the rock. The higher the lap anti-shear strength, the larger the lap anti-shear strength of the interface between the lost-circulation material and the rock, and the harder the lost-circulation material is separated from the rock interface.

In the invention, the mass retention rate can reflect the water dilution resistance, and the higher the mass retention rate, the better the water dilution resistance, and vice versa.

In the invention, the mass retention rate is measured by using a simulation device for plugging of the water-bearing lost circulation formation disclosed in CN113123756A as the test device, the formed gel is placed for 30 min, 500 mL of the placed gel is taken and injected into the test device under the water flow scouring (for specific details, refer to CN113123756A, a simulation device for plugging of water-bearing lost circulation formation), the scouring rate of the water flow is set at 10 m/min, the injection speed of the gel is 20 m/min, water continues to be injected for scouring for 30 min after the injection of said gel is completed, the soured sample is taken out, and the mass retention rate of the sample is calculated. Mass retention rate=mass of sample after scouring/mass of injected gel*100%.

In some embodiments of the present invention, the bearing strength of the lost-circulation material is not less than 7 MPa. For example, 7 MPa, 8 MPa, 9 MPa, 10 MPa, 11 MPa, 12 MPa, and any value within a range consisting of any two numerical values, preferably within the range of 8-10 MPa.

In the invention, the bearing strength is measured by using a simulation device for leaking stoppage of the water-bearing leakage layer disclosed in CN113123756A as the test device, the maximum pressure value of the pressure gauge 17 is read, namely the bearing strength of the lost-circulation material.

In some embodiments of the present invention, the compressive strength of the lost-circulation material is not less than 16 MPa, preferably within the range of 18-25 MPa.

In some embodiments of the present invention, the lost-circulation formation is a water-bearing formation, preferably a flowing water-bearing formation.

In the invention, the position of the lost-circulation formation refers to the position of the lost-circulation formation wellbore.

In some embodiments of the present invention, the temperature of the lost-circulation formation is within the range of 50-180° C.

In some embodiments of the present invention, the lost-circulation composition comprises the following ingredients: a cross-linkable polymer, a cross-linking agent, an enhancer, and a solvent; wherein the cross-linking agent contains a metal cross-linking agent and/or an allyl-type cross-linking agent, and the enhancer is an enhancer I and/or an enhancer II;

The enhancer I comprises a monomer represented by formula (I), dopamine, and an initiator;

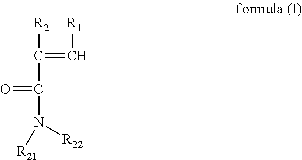

Wherein R₁, R₂, R₂₁ and R₂₂ are each independently hydrogen or a straight or branched chain alkyl group of C₁-C₁₀;

The enhancer II comprises a consolidating material and a set retarder, the consolidating material is a material that can be hydrated and cured when contacting with water, the consolidating material has a compressive strength of more than 10 MPa, and an expansion rate within the range of 0.5-1.5%.

In the invention, the initiator in the enhancer I enables the polymerizable monomers to carry out the secondary cross-linking and curing under the formation conditions in a controllable manner, and a lost-circulation material is formed at the lost-circulation formation. The set retarder in the enhancer II enables the consolidating material to be cured under the formation conditions in a controllable manner, and a lost-circulation material is formed at the lost-circulation formation.

In the invention, the formation conditions refer to the conditions of the formation where an oil-gas well resides, the formation conditions in the invention mainly consider the temperature, because the temperature has the largest influence on an initiator and a set retarder, the lost-circulation composition has desirable plugging effect within the temperature range of 50-180° C.

In the invention, the cross-linkable polymer and the cross-linking agent can be cross-linked upon contact with each other, the lost-circulation composition can be cross-linked to form a gel before or during being injected into the formation, the mass retention rate of the gel when scouring for 30 min at a water flow rate of 10 m/min is 90% or more, so that the system cannot be easily scattered by water; as time goes on, the cross-linking degree gradually increases, the gel can realize strong retention around a wellbore, and finally forms a lost-circulation material at the lost-circulation formation, the lap anti-shear strength of the lost-circulation material is within the range of 0.1-0.14 MPa. The lost-circulation material formed by the lost-circulation composition of the invention has remarkable improvements in water dilution resistance, high-temperature resistance, and the like. The lost-circulation material of the invention is suitable for a water-bearing formation having a temperature of not higher than 180° C., especially a flowing water-bearing formation.

In the present invention, the examples of the straight or branched chain alkyl group of C₁-C₁₀ may be any one of methyl, ethyl, n-propyl, isopropyl, n-butyl, sec-butyl, isobutyl, tert-butyl, n-pentyl, isopentyl, tert-pentyl, neopentyl, n-hexyl, isohexyl, n-heptyl, isoheptyl, 2-methylhexyl, 2-ethylhexyl, 1-methylheptyl, 2-methylheptyl, n-octyl, isooctyl, n-nonyl, isononyl, and 3,5,5-trimethylhexyl.

In some preferred embodiments of the invention, the monomer represented by formula (I) is acrylamide or a derivative thereof.

In the invention, the consolidating material in the enhancer II can be cured, its bonding performance with the water-bearing lost-circulation formation is desirable, and the formed and consolidated lost-circulation material will not be scattered by water after entering the lost-circulation formation. The cross-linkable polymer and the cross-linking agent are initially cross-linked to generate a gel, which is then cured with the consolidating material to form the lost-circulation material.

In the invention, when the lost-circulation composition is used, the added amount and type of the initiator, the retarding agent or the set retarder are controlled, so that the lost-circulation composition is cured at the lost-circulation formation.

In some embodiments of the invention, R₁, R₂, R₂₁, R₂₂, R₃₁, and R₃₂ are each independently hydrogen, or a straight or branched chain alkyl group of C₁-C₆; preferably hydrogen, or a straight or branched chain alkyl group of C₁-C₄, more preferably hydrogen, methyl, or ethyl.

In some embodiments of the invention, the metal cross-linking agent is at least one selected from the group consisting of a zirconium cross-linking agent, a chromium cross-linking agent, and an aluminum cross-linking agent.

In some embodiments of the invention, the allyl-type cross-linking agent is at least one selected from the group consisting of N,N′-methylene bisacrylamide, glycerol triacrylate, ethoxylated trimethylolpropane triacrylate, pentaerythritol triacrylate, pentaerythritol tetraacrylate, and ethoxylated pentaerythritol tetraacrylate.

In the invention, the cross-linking agent does not contain a water-soluble carbon nanotube cross-linking agent. The invention has an excellent cross-linking effect without adding the water-soluble carbon nanotube cross-linking agent.

In the present invention, the cross-linkable polymer may be added in the form of solid particles or a water-in-oil emulsion during the process of preparing a lost-circulation composition; when the cross-linkable polymer is added in the form of solid particles, the lost-circulation composition in the invention shall comprise a solvent (preferably water) for dissolving the solid matter in the composition; when the cross-linkable polymer is added in the form of a water-in-oil emulsion, the solvent (preferably water) in the lost-circulation composition of the present invention is used for preparing the water-in-oil emulsion.

The lost-circulation composition of the invention has a low viscosity in the preparation process, after the composition is injected into a wellbore and in the flowing process in the wellbore, a cross-linkable polymer and a cross-linking agent are initially cross-linked to generate a gel, other ingredients are encapsulated in a network structure formed by the cross-linking process to form an integral whole, the gel cannot be diluted and dispersed when contacting with water. Since the gel contains a large number of hydrogen bonds and has a certain density, it can adhere to the lost-circulation formation and reside around the lost-circulation formation wellbore. Under the temperature and pressure conditions of the formation, an initiator in the enhancer I can activate the monomers represented by formula (I), dopamine, and the like in the system to be polymerized and cross-linked, a lost-circulation material with high compressive strength and multiple cross-links is further generated, so that the water-bearing lost-circulation formation is plugged. Dopamine in the lost-circulation composition can enhance the adhesive force of the gel with the rock, the adhesive property between the cured gel and the lost-circulation formation is desirable, thereby improving the water erosion resistance of the finally generated lost-circulation material.

In the invention, the lost-circulation composition can carry out a primary cross-linking process under a certain temperature to form a gel, and then carry out a secondary cross-linking process to generate a solid-state immobile body so that the gel is completely cured.

In some embodiments of the invention, the cross-linkable polymer is polyacrylamide and/or a polyacrylamide derivative, and the solvent is water; the lost-circulation composition comprises the following ingredients in parts by weight: 0.01-8 parts of a cross-linkable polymer, 0.01-8 parts of a metal cross-linking agent, 0.01-0.9 part of an allyl-type cross-linking agent, 3-30 parts of a monomer represented by formula (I), 0.01-3 parts of dopamine, 0.01-8 parts of an initiator, and 100 parts of water.

In the invention, the polyacrylamide and/or polyacrylamide derivatives are in the form of solid particles, and water is used as a solvent to dissolve solid substances first, the dissolved solid substances are then mixed with the rest of the ingredients.

When the lost-circulation composition of the invention is prepared by selecting the ingredients according to the specific parts by weight, a higher mass retention rate can be obtained in the implementation process, and the generated lost-circulation material has higher compressive strength and better adaptability to the high-temperature environment.

In the present invention, the cross-linkable polymer is preferably polyacrylamide, and the parts by weight thereof may be 0.01 part, 0.5 part, 1 part, 1.5 parts, 2 parts, 2.5 parts, 3 parts, 3.5 parts, 4 parts, 4.5 parts, 5 parts, 5.5 parts, 6 parts, 6.5 parts, 7 parts, 7.5 parts, 8 parts, and any value within a range consisting of any two numerical values.

In the present invention, the parts by weight of dopamine may be 0.01 part, 0.5 part, 1 part, 1.5 parts, 2 parts, 2.5 parts, 3 parts, and any value within a range consisting of any two numerical values.

In the present invention, the parts by weight of the metal cross-linking agent may be 0.01 part, 0.5 part, 1 part, 1.5 parts, 2 parts, 2.5 parts, 3 parts, 3.5 parts, 4 parts, 4.5 parts, 5 parts, 5.5 parts, 6 parts, 6.5 parts, 7 parts, 7.5 parts, 8 parts, and any value within a range consisting of any two numerical values.

In the present invention, the parts by weight of the monomer represented by formula (I) may be 3 parts, 5 parts, 10 parts, 15 parts, 20 parts, 25 parts, 30 parts, and any value within a range consisting of any two numerical values.

In the present invention, the parts by weight of the initiator may be 0.01 part, 0.5 part, 1 part, 1.5 parts, 2 parts, 2.5 parts, 3 parts, 3.5 parts, 4 parts, 4.5 parts, 5 parts, 5.5 parts, 6 parts, 6.5 parts, 7 parts, 7.5 parts, 8 parts, and any value within a range consisting of any two numerical values.

In the present invention, the parts by weight of the allyl-type cross-linking agent may be 0.01 part, 0.1 part, 0.2 part, 0.3 part, 0.4 part, 0.5 part, 0.6 part, 0.7 part, 0.8 part, 0.9 part, and any value within a range consisting of any two numerical values.

In some preferred embodiments, the lost-circulation composition comprises the following ingredients in parts by weight: 0.01-5 parts of polyacrylamide, 0.01-1 parts of dopamine, 0.01-5 parts of a metal cross-linking agent, 5-25 parts of a monomer represented by formula (I), 0.01-5 parts of an initiator, 0.01-5 parts of an allyl-type cross-linking agent, and 100 parts of water;

In some embodiments of the invention, polyacrylamide and dopamine are dissolved in water, and a metal cross-linking agent, monomers, an allyl-type cross-linking agent, an initiator, and the like are respectively added and mixed uniformly to obtain the lost-circulation slurry corresponding to the above-mentioned lost-circulation composition.

In some embodiments of the invention, the cross-linkable polymer has a weight-average molecular weight within the range of 2,500,000-18,000,000 g/mol, for example, 2,500,000 g/mol, 4,000,000 g/mol, 6,000,000 g/mol, 8,000,000 g/mol, 10,000,000 g/mol, 12,000,000 g/mol, 14,000,000 g/mol, 16,000,000 g/mol, 18,000,000 g/mol, and any value within a range consisting of any two numerical values, preferably within the range of 3,000,000-16,000,000 g/mol. The preferred weight-average molecular weight of the polyacrylamide enables the obtained gel to have a higher mass retention rate and retention capacity under flowing water conditions.

In the invention, the weight-average molecular weight of the polymer is measured with gel chromatography.

In some embodiments, the metal cross-linking agent is at least one selected from the group consisting of a zirconium cross-linking agent, a chromium cross-linking agent, and an aluminum cross-linking agent. In the implementation process of the lost-circulation composition of the invention, polyacrylamide is initially subjected to a cross-linking reaction with a metal cross-linking agent to form a gel.

In some preferred embodiments, the zirconium cross-linking agent is zirconium trichloride and/or zirconium oxychloride.

In some preferred embodiments, the chromium cross-linking agent is chromium lactate and/or chromium chloride.

In some preferred embodiments, the aluminum cross-linking agent is aluminum citrate.

In some preferred embodiments, the allyl-type cross-linking agent is at least one selected from the group consisting of N,N′-methylene bisacrylamide, glycerol triacrylate, ethoxylated trimethylolpropane triacrylate, pentaerythritol triacrylate, pentaerythritol tetraacrylate, and ethoxylated pentaerythritol tetraacrylate.

In some preferred embodiments, the cross-linking agent further comprises a silicon cross-linking agent. When the lost-circulation composition of the invention comprises a silicon cross-linking agent, the strength of the system can be improved, and the bonding effect of the gel with the formation can be enhanced.

In some preferred embodiments, the silicon cross-linking agent is at least one selected from the group consisting of sodium silicate, ethyl silicate, and y-methacryloxy propyl trimethoxysilane (KH 570).

In some preferred embodiments, the parts by weight of the silicon cross-linking agent may be within the range of 0.05-12 parts, such as 0.05 part, 0.5 part, 1 part, 2 parts, 3 parts, 4 parts, 5 parts, 6 parts, 7 parts, 8 parts, 9 parts, 10 parts, 11 parts, 12 parts, and any value within a range consisting of any two numerical values, preferably within the range of 0.1-10 parts.

In some preferred embodiments, the initiator is at least one selected from the group consisting of potassium persulfate, ammonium persulfate, sodium persulfate, benzoyl peroxide, azobisisobutyramidine hydrochloride, di-t-butyl peroxide, lauroyl peroxide, azobisisobutyronitrile, and cumene hydroperoxide. The initiator can adapt to different temperatures and can efficiently initiate the cross-linking reaction under the different temperatures so that the gel further forms a lost-circulation material with high compressive strength and multiple cross-links.

In some embodiments of the present invention, the enhancer I further comprises at least one of a monomer represented by formula (II), a monomer represented by formula (III), a monomer represented by formula (IV), a monomer represented by formula (V), and a monomer represented by formula (VI): preferably, the enhancer I comprises a monomer represented by formula (II), a monomer represented by formula (III), a monomer represented by formula (IV), a monomer represented by formula (V), and a monomer represented by formula (VI):

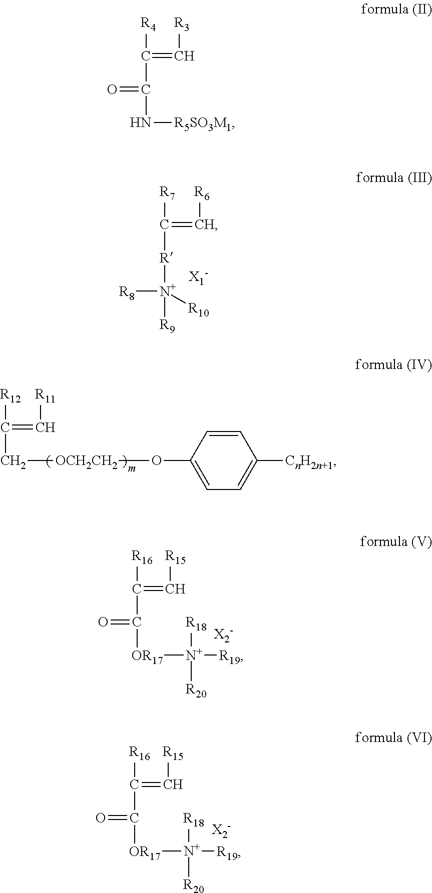

Wherein R₃, R₄, R₆, R₇, R₁₁, R₁₂, R₁₃, R₁₄, R₁₅, R₁₆, R₁₈, R₁₉ and R₂₀ are each independently hydrogen or a straight or branched chain alkyl group of C₁-C₁₀; R₅ and R₁₇ are each independently a straight or branched chain alkylene group of C₁-C₂₀; one of R₈, R₉ and R₁₀ is a straight or branched chain alkyl group of C₁-C₂₀, the other two are each independently hydrogen, or a straight or branched chain alkyl group of C₁-C₁₀, and R′ is a straight or branched chain alkylene group of C₁-C₁₀; M₁ and M₂ are each independently H, Na, Li, or K; X₁ and X₂ are each independently selected from Cl, Br, or I; m is any integer within the range of 4-20, and n is any integer within the range of 3-10.

In some preferred embodiments, R₃, R₄, R₆, R₇, R₁₁, R₁₂, R₁₃, R₁₄, R₁₅, R₁₆, R₁₈, R₁₉ and R₂₀ are each independently hydrogen, or a straight or branched chain alkyl group of C₁-C₆; preferably hydrogen or a straight or branched chain alkyl group of C₁-C₄, more preferably hydrogen, methyl, or ethyl.

In some preferred embodiments, R₅ and R₁₇ are each independently a straight or branched chain alkylene group of C₁-C₂₀, including but not limited to methylene, ethydene, propylidene, isopropylidene, butylidene, isobutylidene, tert-butylidene, pentylidene, and hexylidene; R₅ is preferably isobutylidene; R₁₇ is preferably ethydene.

In some preferred embodiments, R′ is a straight or branched chain alkylene group of C₁-C₁₀, including but not limited to methylene, ethydene, propylidene, isopropylidene, butylidene, isobutylidene, tert-butylidene, pentylidene, and hexylidene; R′ is preferably methylene.

In some preferred embodiments, one of R₈, R₉ and R₁₀ is a straight or branched chain alkyl group of C₈-C₂₀, preferably a straight or branched chain alkyl group of C₁₈, and the other two groups are each independently methyl.

In some embodiments, the monomer represented by formula (II) is 2-acrylamido-2-methylpropanesulfonic acid and/or sodium 2-acrylamido-2-methylpropanesulfonate, the monomer represented by formula (III) is octadecyl dimethyl allyl ammonium chloride, the monomer represented by formula (IV) is allyl nonyl phenol polyoxyethylene ether, the monomer represented by formula (V) is sodium acrylate, and the monomer represented by formula (VI) is acryloyloxyethyl trimethyl ammonium chloride.

In some preferred embodiments, the monomer represented by formula (II) is used in an amount of 0.2-20 parts by weight, more preferably 2-15 parts by weight, based on 100 parts by weight of water.

In some preferred embodiments, the monomer represented by formula (III) is used in an amount of 0.5-20 parts by weight, more preferably 1-15 parts by weight, based on 100 parts by weight of water.

In some preferred embodiments, the monomer represented by formula (IV) is used in an amount of 0.2-5 parts by weight, more preferably 0.5-4 parts by weight, based on 100 parts by weight of water.

In some preferred embodiments, the monomer represented by formula (V) is used in an amount of 0.5-20 parts by weight, more preferably 1-15 parts by weight, based on 100 parts by weight of water.

In some preferred embodiments, the monomer represented by formula (VI) is used in an amount of 0.5-10 parts by weight, more preferably 1-8 parts by weight, based on 100 parts by weight of water.

In some preferred embodiments, the lost-circulation composition further comprises a weighting agent; preferably, the weighting agent is at least one selected from the group consisting of calcium carbonate, barite, and iron ore powder, more preferably barite.

In some preferred embodiments, the weighting agent is present in an amount of 5-200 parts by weight, preferably 10-150 parts by weight, based on 100 parts by weight of water.

In some embodiments, the lost-circulation composition further comprises a retarding agent.

In some preferred embodiments, the retarding agent is p-benzoquinone.

In some preferred embodiments, the retarding agent is present in an amount of no greater than 1 part by weight, preferably 0.1-0.6 parts by weight, based on 100 parts by weight of water.

The density of the lost-circulation composition at 25° C. is within the range of 1-2 g/cm³, preferably within the range of 1.2-1.65 g/cm³.

In other embodiments of the present invention, the cross-linkable polymer is polyacrylamide and/or a polyacrylamide derivative, the cross-linkable polymer is present in the form of a water-in-oil emulsion comprising the cross-linkable polymer, oil, water, and an emulsifier; the lost-circulation composition comprises the following ingredients in parts by weight: 100 parts of water-in-oil emulsion, 0.01-8 parts of a cross-linking agent, 3-30 parts of monomer represented by formula (I), 0.01-2 parts of dopamine, and 0.01-8 parts of an initiator.

In some preferred embodiments of the invention, the mass ratio of the cross-linkable polymer to the oil, water, and the emulsifier is (0.5-15):100:(50-100):(0.05-10), such as 0.5:100:50:0.05, 3:100:60:3, 10:100:80:7, 13:100:90:2, 8:100:92:5, 15:100:100:10, and any value within a range consisting of any two numerical values, more preferably (1-10):100:(60-90):(0.1-5). The above mass ratios enable a strong gel to be obtained with a higher mass retention rate.

In the invention, the water-in-oil emulsion is prepared with a method comprising the following steps:

Firstly, adding polyacrylamide and/or a polyacrylamide derivative into water and stirring, introducing an emulsifier into an oil phase, stirring and dissolving, then slowly adding a polyacrylamide solution and/or a polyacrylamide derivative solution into the oil phase, and stirring and emulsifying at the stirring speed of 8,000-12,000 r/min to obtain the water-in-oil emulsion.

When the polyacrylamide and the polyacrylamide derivative are in the form of a water-in-oil emulsion, after the lost-circulation composition enters the lost-circulation formation and contacting with formation water, the water-in-oil emulsion breaks the emulsion, the polyacrylamide and the polyacrylamide derivative will be released immediately to carry out a cross-linking with a cross-linking agent in a system to form a gel, which encapsulates the monomers, an initiator and the like in a network structure formed by the cross-linking process so that the system will not be scattered by water.

In some preferred embodiments, the oil is at least one selected from the group consisting of waste white oil, waste diesel oil, waste engine oil, and waste edible oil. The oil in the water-in-oil emulsion in the invention can use the waste oil phase, thereby turning trash into treasure.

In some preferred embodiments, the cross-linkable polymer is anionic polyacrylamide, and the anionic polyacrylamide has a weight-average molecular weight within the range of 2,500,000-10,000,000 g/mol, such as 2,500,000 g/mol, 4,000,000 g/mol, 6,000,000 g/mol, 8,000,000 g/mol, 10,000,000 g/mol, and any value within a range consisting of any two numerical values, preferably within the range of 3,000,000-8,000,000 g/mol.

In the present invention, the weight-average molecular weight of the polymer is measured through gel chromatography.

In some preferred embodiments, the emulsifier is at least one selected from the group consisting of octylphenol polyoxyethylene ether-10 (OP-10), octylphenol polyoxyethylene ether-15 (OP-15), nonylphenol polyoxyethylene ether-10 (NP-10), nonylphenol polyoxyethylene ether-15 (NP-15), polyoxyethylene (20) sorbitan monolaurate (Tween-20, T-20), polyoxyethylene (60) sorbitan monostearate (Tween-60, T-60), sorbitan monooleate (Span-80, S-80), sorbitan trioleate (Span-85, S-85), and sodium dodecylbenzene sulfonate.

In some embodiments of the invention, the enhancer I further comprises at least one of a monomer represented by formula (II), a monomer represented by formula (III), a monomer represented by formula (IV), a monomer represented by formula (V), and a monomer represented by formula (VI); preferably, the monomer comprises a monomer represented by formula (II), a monomer represented by formula (III), a monomer represented by formula (IV), a monomer represented by formula (V), and a monomer represented by formula (VI):

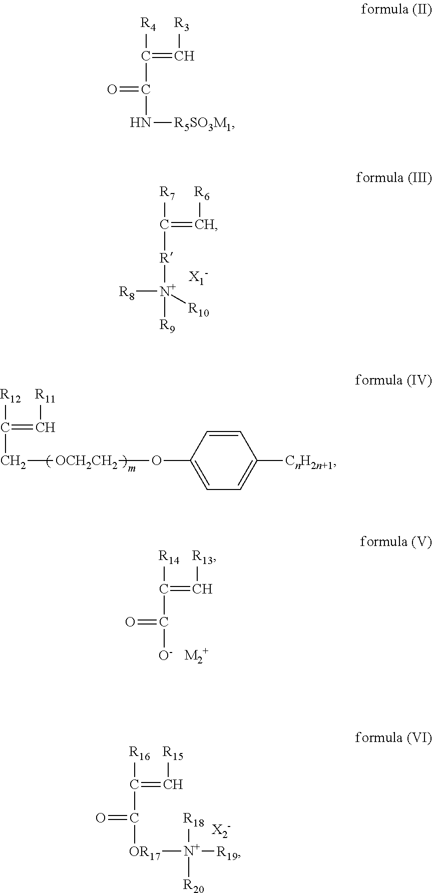

wherein R₃, R₄, R₆, R₇, R₁₁, R₁₂, R₁₃, R₁₄, R₁₅, R₁₆, R₁₈, R₁₉ and R₂₀ are each independently hydrogen or a straight or branched chain alkyl group of C₁-C₁₀; R₅ and R₁₇ are each independently a straight or branched chain alkylene group of C₁-C₂₀; one of R₈, Ry and R₁₀ is a straight or branched chain alkyl group of C₁-C₂₀, the other two are each independently hydrogen, or a straight or branched chain alkyl group of C₁-C₁₀, and R′ is a straight or branched chain alkylene group of C₁-C₁₀; Mi and M₂ are each independently H, Na, Li, or K; X₁ and X₂ are each independently selected from Cl, Br, or I; m is any integer within the range of 4-20, and n is any integer within the range of 3-10.

For the specific preferred embodiments of the substituents, please refer to the preceding specification, the content will not be repeatedly described herein.

In some embodiments, the monomer represented by formula (II) is 2-acrylamido-2-methylpropanesulfonic acid and/or sodium 2-acrylamido-2-methylpropanesulfonate, the monomer represented by formula (III) is octadecyl dimethyl allyl ammonium chloride, the monomer represented by formula (IV) is allyl nonyl phenol polyoxyethylene ether, the monomer represented by formula (V) is sodium acrylate, and the monomer represented by formula (VI) is acryloyloxyethyl trimethyl ammonium chloride.

In some preferred embodiments, the monomer represented by formula (II) is used in an amount of 0.2-20 parts by weight, more preferably 2-15 parts by weight, based on 100 parts by weight of the water-in-oil emulsion.

In some preferred embodiments, the monomer represented by formula (III) is used in an amount of 0.5-20 parts by weight, more preferably 1-15 parts by weight, based on 100 parts by weight of the water-in-oil emulsion.

In some preferred embodiments, the monomer represented by formula (IV) is used in an amount of 0.2-5 parts by weight, more preferably 0.5-4 parts by weight, based on 100 parts by weight of the water-in-oil emulsion.

In some preferred embodiments, the monomer represented by formula (V) is used in an amount of 0.5-20 parts by weight, more preferably 1-15 parts by weight, based on 100 parts by weight of the water-in-oil emulsion.

In some preferred embodiments, the monomer represented by formula (VI) is present in an amount of 0.5-10 parts by weight, more preferably 1-8 parts by weight, based on 100 parts by weight of the water-in-oil emulsion.

In the invention, the water-in-oil emulsion, the monomers, the initiator, the cross-linking agent, and the like are mixed and stirred uniformly to obtain the lost-circulation slurry corresponding to the lost-circulation composition.

When the invention selects ingredients according to the specific weight parts to prepare the lost-circulation composition, a higher mass retention rate can be obtained in the implementation process, the generated lost-circulation material has a higher compressive strength and better adaptability to the high-temperature environment.

The parts by weight of the monomer represented by formula (I) may be 3 parts, 5 parts, 10 parts, 15 parts, 20 parts, 25 parts, 30 parts, and any value within a range consisting of any two numerical values.

The parts by weight of the initiator may be 0.01 part, 0.5 part, 1 part, 1.5 parts, 2 parts, 2.5 parts, 3 parts, 3.5 parts, 4 parts, 4.5 parts, 5 parts, 5.5 parts, 6 parts, 6.5 parts, 7 parts, 7.5 parts, 8 parts, and any value within a range consisting of any two numerical values.

The parts by weight of the cross-linking agent may be 0.01 part, 0.5 part, 1 part, 1.5 parts, 2 parts, 2.5 parts, 3 parts, 3.5 parts, 4 parts, 4.5 parts, 5 parts, 5.5 parts, 6 parts, 6.5 parts, 7 parts, 7.5 parts, 8 parts, and any value within a range consisting of any two numerical values.

In some preferred embodiments, the lost-circulation composition comprises the following ingredients in parts by weight: 100 parts of a water-in-oil emulsion, 5-25 parts of the monomer represented by formula (I), 0.01-1 parts of dopamine, 0.01-5 parts of an initiator, and 0.01-5 parts of a cross-linking agent.

In some preferred embodiments of the present invention, the initiator is at least one selected from the group consisting of potassium persulfate, ammonium persulfate, sodium persulfate, benzoyl peroxide, azobisisobutyramidine hydrochloride, di-t-butyl peroxide, lauroyl peroxide, azobisisobutyronitrile, and cumene hydroperoxide. The preferred initiator can adapt to different temperatures, and can efficiently initiate the cross-linking reaction under different temperatures so that the gel further generates the gel with multiple cross-links and higher compressive strength.

In some preferred embodiments, the cross-linking agent comprises an allyl-type cross-linking agent and/or an organometallic cross-linking agent.

In some preferred embodiments, the cross-linking agent is a mixture of an allyl-type cross-linking agent and an organometallic cross-linking agent, wherein the mass ratio of the allyl-type cross-linking agent to the organometallic cross-linking agent is 1:(0.3-8), preferably 1:(0.5-5).

In some preferred embodiments, the allyl-type cross-linking agent is at least one selected from the group consisting of N,N′-methylene bisacrylamide, glycerol triacrylate, ethoxylated trimethylolpropane triacrylate, pentaerythritol triacrylate, pentaerythritol tetraacrylate, and ethoxylated pentaerythritol tetraacrylate.

In some preferred embodiments, the organometallic cross-linking agent is at least one selected from the group consisting of an organozirconium cross-linking agent, an organochromium cross-linking agent, and an organoaluminium cross-linking agent.

In some preferred embodiments, the organozirconium cross-linking agent is zirconium citrate.

In some preferred embodiments, the organic chromium cross-linking agent is chromium lactate.

In some preferred embodiments, the organoaluminum cross-linking agent is aluminum citrate.

In some preferred embodiments, the cross-linking agent further comprises a silicon cross-linking agent.

When the cross-linking agent in the invention comprises a silicon cross-linking agent, the strength of the system can be improved, and the bonding effect between the gel and the formation can be enhanced.

In some preferred embodiments, the silicon cross-linking agent is at least one selected from the group consisting of sodium silicate, ethyl silicate, and y-methacryloxy propyl trimethoxysilane (KH 570).

In some preferred embodiments, the cross-linking agent is a mixture of an allyl-type cross-linking agent, an organometallic cross-linking agent, and a silicon cross-linking agent, wherein the mass ratio of the allyl-type cross-linking agent to the organometallic cross-linking agent and the silicon cross-linking agent is 1:(0.3-8):(0.1-12), preferably 1:(0.5-5):(0.2-10).

In some preferred embodiments, the lost-circulation composition further comprises a weighting agent.

In some preferred embodiments, the weighting agent is at least one selected from the group consisting of calcium carbonate, barite, and iron ore powder, preferably barite.

In some preferred embodiments, the weighting agent is present in an amount of 5-120 parts by weight, more preferably 10-100 parts by weight, based on 100 parts by weight of the water-in-oil emulsion.

In some embodiments, the lost-circulation composition further comprises a retarding agent.

In some preferred embodiments, the retarding agent is p-benzoquinone.

In some preferred embodiments, the retarding agent is present in an amount of no greater than 1 part by weight, preferably 0.1-0.6 part by weight, based on 100 parts by weight of the water-in-oil emulsion.

In some preferred embodiments, the density of the lost-circulation composition at 25° C. is within the range of 1.2-1.78 g/cm³.

In some other embodiments of the present invention, the lost-circulation composition further comprises a salt-resistant polymer, the salt-resistant polymer and the cross-linkable polymer form a water non-dispersible material; the lost-circulation composition comprises the following ingredients in parts by weight: 10-15 parts of a water non-dispersible material, 0.1-4 parts of a cross-linking agent, 50-200 parts of a consolidating material, and 100 parts of water.

In the present invention, the lost-circulation composition further comprises the following ingredients in parts by weight: 12-15 parts of a water non-dispersible material, 1-3 parts of a cross-linking agent, 150-200 parts of a consolidating material, 0.5-5 parts of a set retarder and 100 parts of water. The adoption of the optimal conditions is beneficial to improving the properties of the consolidating lost-circulation slurry, namely, the slurry has the desirable properties of high mass retention rate, cohesiveness, and compressive strength.

When the invention selects the ingredients according to the specific parts by weight to prepare the lost-circulation composition, a higher mass retention rate can be obtained in the implementation process, and the generated lost-circulation material has a higher compressive strength and better adaptability to the high-temperature environment.

In some preferred embodiments, the cross-linkable polymer is a non-ionic polymer, preferably selected from polyacrylamide and/or a polyacrylamide derivative.

In some preferred embodiments, the cross-linkable polymer has a weight-average molecular weight within the range of 2,000,000-14,000,000 g/mol, for example 2,000,000 g/mol, 2,500,000 g/mol, 3,000,000 g/mol, 4,000,000 g/mol, 5,000,000 g/mol, 6,000,000 g/mol, 7,000,000 g/mol, 8,000,000 g/mol, 9,000,000 g/mol, 10,000,000 g/mol, 12,000,000 g/mol, 14,000,000 g/mol, and any value within a range consisting of any two numerical values, more preferably within the range of 2,000,000-14,000,000 g/mol. The preferred weight-average molecular weight of the polyacrylamide and polyacrylamide derivatives enables the obtained gel to have a higher mass retention rate and retention capacity under flowing water conditions.

In the present invention, the weight-average molecular weight of the polymer is measured with gel chromatography.

In some preferred embodiments, the salt-resistant polymer is at least one selected from the group consisting of SMPFL-C, SMHV-C, and SMVIS-1.

In the invention, the salt-resistant polymer SMPFL-C, SMHV-C, and SMVIS-1 are commercially available from the SINOPEC Research Institute of Petroleum Engineering Co., Ltd.

In the present invention, the water non-dispersible material comprises a salt-resistant polymer and a nonionic polymer; the mass ratio of the salt-resistant polymer to the nonionic polymer is 10:(0.5-3), preferably 10:(1-2). The salt-resistant polymer and the nonionic polymer are conducive to improving the mass retention rate of the consolidating lost-circulation slurry so that the consolidating lost-circulation slurry can reside in the lost-circulation formation under the condition of flowing water and is not scattered by water.

In the present invention, there is a wide selection range of methods for producing the water non-dispersible material, as long as the weight ratio of ingredients in the water non-dispersible material satisfies the above-mentioned limitation.

In some preferred embodiments, the consolidating material comprises cement or lime, slag, bentonite, gypsum, and an acidic substance; the acidic substance is hydrochloric acid and/or hydroxyethylidene diphosphonic acid.

In some preferred embodiments, the mass ratio of the cement or lime to the slag, the bentonite, the gypsum, and the acidic substance is (4-10):(8-20):(1-2):(1-3):(0.2-1).

In the invention, after the consolidating material is cured under the action of the cross-linking agent, its bonding performance with the water-bearing lost-circulation formation is better.

In some preferred embodiments, the set retarder is selected from 2-acrylamido-2-methylpropanesulfonic acid polymer and/or hydroxycarboxylic acid polymer.

Further, the weight-average molecular weight of the 2-acrylamido-2-methylpropanesulfonic acid polymer is within the range of 1,000,000-10,000,000 g/mol.

Furthermore, the hydroxycarboxylic acid polymer may be SCR-3, wherein SCR-3 is a hydroxycarboxylic acid polymer produced by the SINOPEC Research Institute of Petroleum Engineering Co., Ltd.

In the present invention, the parts by weight of the set retarder are not more than 5 parts, more preferably 0.1-2 parts, based on 100 parts by weight of water.

In some preferred embodiments, the lost-circulation composition further comprises 0-40 parts by weight of a density modifier, based on 100 parts by weight of water.

In some preferred embodiments, the density modifier may be a weighting agent or a lightening agent; the weighting agent is at least one selected from the group consisting of calcium carbonate, barite, or iron ore powder; the lightening agent is at least one selected from the group consisting of flowing beads, hollow glass beads, and polymer hollow beads. The above ingredients are commercially available. The density of the lost-circulation composition in the invention can be regulated by adjusting the additive amount of the density modifier.

In some embodiments of the invention, the density of the lost-circulation composition at 25° C. after mixing is within the range of 1-2 g/cm³, preferably within the range of 1.2-1.65 g/cm³.

Unless otherwise specified in the invention, the density is measured with the method stipulated in the China National Standard GB/T16783.1-2014.

The second aspect of the invention provides a lost-circulation material obtained by curing the aforementioned lost-circulation composition.

In some embodiments of the invention, the curing temperature is within the range of 50-180° C.

In some embodiments of the invention, the lost-circulation material has a compressive strength within the range of 15-25 MPa.

The third aspect of the invention provides a use of the aforementioned lost-circulation composition or the aforesaid lost-circulation material in plugging the oil well formation; the oil well formation is preferably a flowing water-bearing oil well formation with a temperature range of 50-180° C.

The lost-circulation material formed with the lost-circulation composition of the invention has the properties of water dilution resistance and high-temperature resistance, can reside in the lost-circulation formation after entering the water-bearing formation, especially a flowing water-bearing formation, and finally cures under the formation condition and forms a plug with the compressive strength within the range of 15-25 MPa, thereby solving the difficult problem of lost-circulation of the flowing water-bearing formation.

After injecting the lost-circulation composition of the invention into the water-bearing formation, the polyacrylamide and/or a polyacrylamide derivative carry out a cross-linking reaction with a cross-linking agent to generate a gel, and encapsulate other ingredients in a network structure formed by the cross-linking process, so that the system will not be scattered by water, after the system resides, the initiator initiates polymerization and generates cross-linking or the consolidating material is cured under the temperature and pressure conditions of the formation, so that a lost-circulation material with multiple cross-links and higher compressive strength is further generated, thereby plugging the water-bearing lost-circulation formation.

The lost-circulation composition of the invention is applicable to any water-bearing formation and obviously has a better plugging effect than the existing lost-circulation composition on the flowing water-bearing formation with a wide temperature range.

When the lost-circulation composition or the lost-circulation material is used for plugging the formation cracks, particularly cracks of the flowing water-bearing formation, the lost-circulation composition or the lost-circulation material may have higher compressive strength in the formation environments with different temperatures, thereby solving the difficult problem regarding the lost-circulation of the water-bearing formation.

The fourth aspect of the invention provides a method of plugging an oil well, characterized in that the method comprises: injecting the aforementioned lost-circulation composition directly into cracks in the oil well formation such that the lost-circulation composition forms a gel during the process of injection into the formation, or injecting a gel into cracks in the oil well formation after the aforesaid lost-circulation composition forms the gel, which is cured at the lost-circulation formation under the formation conditions to form a lost-circulation material; wherein the mass retention rate of the gel when scouring at 50-180° C. for 30 min at a water flow rate of 10 m/min is 90% or more; and the lap anti-shear strength of the lost-circulation material is within the range of 0.1-0.14 MPa.

During the injection process of the lost-circulation composition of the invention, the polyacrylamide and/or polyacrylamide derivatives initially carry out a cross-linking reaction with the cross-linked reagent to generate a gel, which encapsulates other ingredients in a network structure formed by the cross-linking process, so that the system will not be scattered by water, and the mass retention rate for resisting the water scouring can reach 96%. The gel formed in the invention can realize strong retention around a wellbore and is cured under the temperature and pressure environment of the formation to generate a lost-circulation material having a compressive strength of up to 25 MPa, such that the lost-circulation formation is finally plugged.

Compared with the existing lost-circulation composition, the lost-circulation material formed by the lost-circulation composition has remarkable improvements in the aspects of water dilution resistance, high-temperature resistance, and the like. The lost-circulation material of the invention is suitable for a water-bearing formation with a temperature range of 50-180° C., especially a flowing water-bearing formation.

In the invention, an appropriate lost-circulation composition is selected according to the on-site formation conditions, given that the temperature has the largest influence on the reaction, the stratum temperature is mainly considered in the simulated formation conditions, and considering that the underground is an airtight space so that the conditions of gel formation and curing of the formation can be simulated under the airtight conditions of a certain temperature or injecting the gel into water at a certain temperature. The lost-circulation slurry obtained after mixing the lost-circulation mixture can form a gel and be cured under the airtight condition at a certain temperature so it is considered that lost-circulation slurry can also form a gel and be cured under similar formation conditions. In addition, the flowing water-bearing formation is simulated by water injection and scouring.

In the following examples and comparative examples, if the specific conditions were not indicated, the operations were carried out according to conventional conditions or conditions recommended by the manufacturer. Provided that the manufactures of the reagents or instruments were not indicated, each was the conventional commercially available product.

Chemical consolidating material SMHD-1, was a commercially available product from the SINOPEC Research Institute of Petroleum Engineering Co., Ltd.

Chemical consolidating material SMHD-2, was a commercially available product from the SINOPEC Research Institute of Petroleum Engineering Co., Ltd.

Chemical consolidating material SMPFL-C, was a commercially available product from the SINOPEC Research Institute of Petroleum Engineering Co., Ltd.

Chemical consolidating material SMHV-C, was a commercially available product from the SINOPEC Research Institute of Petroleum Engineering Co., Ltd.

Chemical consolidating material SMVIS-1, was a commercially available product from the SINOPEC Research Institute of Petroleum Engineering Co., Ltd.

The test methods were as follows:

Density: the test was performed using a densitometer according to the method stipulated in the China National Standard GB/T16783.1-2014.

Compressive strength: the test was carried out according to the method stipulated in the China National Standard GB/T50266-99.

Lap anti-shear strength: it was measured according to the method stipulated in the China National Standard GB 7124-1986, except that the metal herein was replaced with the core slices with the same specification, the gel was smeared on the lap joint area of the limestone core slices, the two core slices prepared in this way were lightly covered, the core slices were pressed for 1 hour under the pressure of 0.5 MPa, and the lap anti-shear strength of the sample after curing was measured.

Bearing strength: the formed gel was placed for 30 min, and 500 mL of the placed gel was taken and injected into the test device under the water flow scouring (for specific details, refer to CN113123756A, a simulation device for leaking stoppage of water-bearing leakage layer), the water flow rate was set at 10 m/min, the injection speed of the gel was 20 m/min, water was continuously injected for scouring after the injection of said gel was completed, water was continuously injected for scouring after the formed gel was completely cured, the maximum pressure value of a pressure gauge 17 (shown in FIG. 1 in CN113123756A) was read, namely the bearing strength of the cured sample.

Mass retention rate: the formed gel was placed for 30 min, and 500 mL of the placed gel was taken and injected into the test device under the water flow scouring (for specific details, refer to CN113123756A, a simulation device for leaking stoppage of water-bearing leakage layer), the scouring rate of the water flow was set at 10 m/min, the injection speed of the gel was 20 m/min, water continued to be injected for scouring for 30 min after the injection of said gel was completed, the scoured sample was taken out, and the mass retention rate of the sample was calculated.

Mass retention rate=mass of sample after scouring/mass of injected gel*100%.

### Example 1

The lost-circulation slurry was prepared according to the formula of the lost-circulation composition in Example 1 of Table 1, and the specific preparation method was as follows: 100 parts of water was weighted, 0.01 part of polyacrylamide was added into water, and stirred at a stirring rate of 1,000 r/min until the mixture was completely dissolved, 0.01 part of zirconium oxychloride was subsequently added and stirring for 5 min, 1 part of dopamine was added and stirred for 5 min, 0.005 part of ethoxylated trimethylolpropane triacrylate, 0.005 part of pentaerythritol tetra-acrylate, 10 parts of acrylamide, 2 parts of 2-acrylamide-2-methylpropanesulfonic acid, 3 parts of octadecyl dimethyl allyl ammonium chloride, 0.5 part of allyl nonyl phenol polyoxyethylene ether, 0.1 part of ethyl silicate, 0.01 part of azobisisobutyronitrile, and 10 parts of iron ore powder were added into the solution in sequence, the materials were stirred and blended uniformly to obtain a lost-circulation slurry.

The density of the lost-circulation slurry at 25° C. was measured to be 1.3 g/cm³ according to the aforementioned method. Under the airtight condition of 100° C., the time for the lost-circulation slurry to generate a gel was 15 min, and the time for reaching the complete curing was 30 min. The formed gel was subjected to water injection and scouring by using a testing device, and the mass retention rate of the gel was calculated at 95%. After the gel was completely cured to form a lost-circulation material, the test results indicated that the bearing strength of the lost-circulation material was 7 MPa, the lap anti-shear strength was 0.11 MPa, and the compressive strength was 22.3 MPa.

### Example 2

The lost-circulation slurry was prepared according to the formula of the lost-circulation composition in Example 2 of Table 1 and the method in Example 1.

The density of the lost-circulation slurry at 25° C. was measured to be 1.5 g/cm³ according to the aforementioned method. Under the airtight condition of 80° C., the time for the lost-circulation slurry to generate a gel was 22 min, and the time for reaching the complete curing was 60 min. The formed gel was subjected to water injection and scouring by using a testing device, and the mass retention rate of the gel was calculated at 93%. After the gel was completely cured to form a lost-circulation material, the test results indicated that the bearing strength of the lost-circulation material was 7 MPa, the lap anti-shear strength was 0.10 MPa, and the compressive strength was 24.1 MPa.

### Example 3

The lost-circulation slurry was prepared according to the formula of the lost-circulation composition in Example 3 of Table 1 and the method in Example 1.

The density of the lost-circulation slurry at 25° C. was measured to be 1.2 g/cm³ according to the aforementioned method. Under the airtight condition of 50° C., the time for the lost-circulation slurry to generate a gel was 15 min, and the time for reaching the complete curing was 80 min. The formed gel was subjected to water injection and scouring by using a testing device, and the mass retention rate of the gel was calculated at 96%. After the gel was completely cured to form a lost-circulation material, the test results indicated that the bearing strength of the lost-circulation material was 7 MPa, the lap anti-shear strength was 0.13 MPa, and the compressive strength was 25 MPa.

### Example 4

The lost-circulation slurry was prepared according to the formula of the lost-circulation composition in Example 4 of Table 1 and the method in Example 1.

The density of the lost-circulation slurry at 25° C. was measured to be 1.38 g/cm³ according to the aforementioned method. Under the airtight condition of 120° C., the time for the lost-circulation slurry to generate a gel was 23 min, and the time for reaching the complete curing was 67 min. The formed gel was subjected to water injection and scouring by using a testing device, and the mass retention rate of the gel was calculated at 94.7%. After the gel was completely cured to form a lost-circulation material, the test results indicated that the bearing strength of the lost-circulation material was 7 MPa, the lap anti-shear strength was 0.12 MPa, and the compressive strength was 21.9 MPa.

### Example 5

The lost-circulation slurry was prepared according to the formula of the lost-circulation composition in Example 5 of Table 1 and the method in Example 1.

The density of the lost-circulation slurry at 25° C. was measured to be 1.65 g/cm³ according to the aforementioned method. Under the airtight condition of 150° C., the time for the lost-circulation slurry to generate a gel was 10 min, and the time for reaching the complete curing was 30 min. The formed gel was subjected to water injection and scouring by using a testing device, and the mass retention rate of the gel was calculated at 93.7%. After the gel was completely cured to form a lost-circulation material, the test results indicated that the bearing strength of the lost-circulation material was 7 MPa, the lap anti-shear strength was 0.14 MPa, and the compressive strength was 22.8 MPa.

### Example 6

The lost-circulation slurry was prepared according to the formula of the lost-circulation composition in Example 3 of Table 1 and the method in Example 1, except that the silicon cross-linking agent was not added.

The density of the lost-circulation slurry at 25° C. was measured to be 1.2 g/cm³ according to the aforementioned method. Under the airtight condition of 50° C., the time for the lost-circulation slurry to generate a gel was 15 min, and the time for reaching the complete curing was 80 min. The formed gel was subjected to water injection and scouring by using a testing device, and the mass retention rate of the gel was calculated at 90%. After the gel was completely cured to form a lost-circulation material, the test results indicated that the bearing strength of the lost-circulation material was 7 MPa, the lap anti-shear strength was 0.11 MPa, and the compressive strength was 18 MPa.

### Comparative Example 1

The lost-circulation slurry was prepared according to the formula of the lost-circulation composition in Example 3 of Table 1 and the method in Example 1, except that the dopamine was not added.

The density of the lost-circulation slurry at 25° C. was measured to be 1.2 g/cm³ according to the aforementioned method. Under the airtight condition of 50° C., the time for the lost-circulation slurry to generate a gel was 20 min, and the time for reaching the complete curing was 90 min. The formed gel was subjected to water injection and scouring by using a testing device, and the mass retention rate of the gel was calculated to be only 65%. After the gel was completely cured to form a lost-circulation material, the test results indicated that the bearing strength of the lost-circulation material was merely 1.2 MPa, the lap anti-shear strength was 0.016 MPa, and the compressive strength was 12 MPa. As can be seen, the retention effect of the finally formed lost-circulation material in the flowing water lost-circulation formation was poor.

TABLE 1

| Ingredients | Example 1 | | Example 2 | | Example 3 | | Example 4 | | Example 5 | |
|---|---|---|---|---|---|---|---|---|---|---|
| Water | 100 | parts | 100 | parts | 100 | parts | 100 | parts | 100 | parts |
| Polyacrylamide | 0.01 part, the | | 8 parts, the | | 1 part, the | | 0.8 part, the | | 4 parts, the | |
| | weight-average | | weight-average | | weight-average | | weight-average | | weight-average | |
| | molecular | | molecular | | molecular | | molecular | | molecular | |
| | weight is | | weight is | | weight is | | weight is | | weight is | |
| | 3,000,000 | | 16,000,000 | | 8,000,000 | | 10,000,000 | | 3,000,000 | |
| | g/mol | | g/mol | | g/mol | | g/mol | | g/mol | |
| Dopamine | 1 | part | 0.01 | part | 0.5 | part | 0.9 | part | 0.3 | part |

| | | | | | |
|---|---|---|---|---|---|
| Metal | 0.01 part of | 5 parts of | 2 parts of | 3 parts of | 1.5 parts of |
| cross-linking | zirconium | chromium | chromium | zirconium | aluminum |
| agent | oxychloride | lactate | chloride | trichloride | citrate |
| Monomer | 10 parts of | 20 parts of | 5 parts of | 15 parts of | 25 parts of |
| represented | acrylamide | acrylamide | acrylamide | acrylamide | acrylamide |
| by formula | | | | | |
| (I) | | | | | |
| Initiator | 0.01 part of | 8 parts of | 0.2 part of | 0.8 part of | 0.8 parts of |
| | azobisisobutyronitrile | cumene | potassium | benzoyl | di-tert-butyl |
| | | hydroperoxide | persulfate | peroxide | peroxide |
| Allyl-type | 0.005 part of | 0.25 part of | 0.3 part of | 0.25 part of | 0.1 part of |
| cross-linking | ethoxylated | ethoxylated | N,N′-methylene | N,N′-methylene | ethoxylated |
| agent | trimethylolpropane | trimethylolpropane | bisacrylamide, | bisacrylamide, | trimethylolpropane |
| | triacrylate, | triacrylate, | 0.3 part of | 0.25 part of | triacrylate, |
| | 0.005 part of | 0.25 part of | glycerol | pentaerythritol | 0.1 part of |
| | pentaerythritol | ethoxylated | triacrylate, 0.3 | triacrylate, 0.25 | pentaerythritol |
| | tetraacrylate | trimethylolpropane | part of | part of | tetraacrylate, 0.1 |
| | | triacrylate | pentaerythritol | ethoxylated | part of |
| | | | triacrylate | pentaerythritol | ethoxylated |
| | | | | tetraacrylate | pentaerythritol |
| | | | | | tetraacrylate |
| Monomer | 2 parts of | 20 parts of | 15 parts of | 10 parts of | 5 parts of |
| represented | 2-acrylamido-2- | 2-acrylamido-2- | 2-acrylamido-2- | 2-acrylamido-2- | 2-acrylamido-2- |
| by formula | methyl | methyl | methyl | methyl | methyl |
| (II) | propanesulfonic | propanesulfonic | propanesulfonic | propanesulfonic | propanesulfonic |
| | acid | acid | acid | acid | acid |
| Monomer | 3 parts of | 12 parts of | 15 parts of | 10 parts of | 1 part of |
| represented | octadecyl | octadecyl | octadecyl | octadecyl | octadecyl |
| by formula | dimethyl allyl | dimethyl allyl | dimethyl allyl | dimethyl allyl | dimethyl allyl |
| (III) | ammonium | ammonium | ammonium | ammonium | ammonium |
| | chloride | chloride | chloride | chloride | chloride |
| Monomer | 0.5 part of allyl | 4 parts of allyl | 1 part of allyl | 3 parts of allyl | 2 parts of allyl |
| represented | nonylphenol | nonylphenol | nonylphenol | nonylphenol | nonylphenol |
| by formula | polyoxyethylene | polyoxyethylene | polyoxyethylene | polyoxyethylene | polyoxyethylene |
| (IV) | ether | ether | ether | ether | ether |
| Silicon | 0.1 part of | 10 parts of | 5 parts of | 8 parts of | 6 parts of |
| cross-linking | ethyl | KH570 | sodium | ethyl | KH570 |
| agent | silicate | | silicate | silicate | |
| Density | 10 parts of | 150 parts of | 30 parts of | 50 parts of | 50 parts of |
| modifier | iron | calcium | calcium | barite | barite |
| | ore powder | carbonate | carbonate | | |

### Example 7

The lost-circulation slurry was prepared according to the formula of the lost-circulation composition in Example 7 of Table 2.

### (1) Preparation of a Water-In-Oil Emulsion:

5 parts of anionic polyacrylamide with a weight-average molecular weight of 3,000,000 g/mol was initially added into 90 parts of water, stirred and dissolved to obtain a polyacrylamide solution; 3 parts of an emulsifier OP-10 was introduced into 100 g of waste white oil and stirred and dissolved to obtain an oil phase; the obtained polyacrylamide solution was then slowly added into the oil phase, subjected to stirring and emulsifying at a stirring speed of 8,000 r/min to produce a water-in-oil emulsion;

### (2) Preparation of a Lost-Circulation Slurry:

The water-in-oil emulsion obtained in step (1) was mixed uniformly with other ingredients to obtain a lost-circulation slurry.

The density of the lost-circulation slurry at 25° C. was measured to be 1.05 g/cm³ according to the aforementioned method. The obtained lost-circulation slurry was injected into water at the temperature of 60° C., the time for the lost-circulation slurry to generate a gel was 45s, and the time for reaching the complete curing was 40 min. The formed gel was subjected to water injection and scouring by using a testing device, and the mass retention rate of the gel was calculated at 97.5%. After the gel was completely cured to form a lost-circulation material, the test results indicated that the bearing strength of the lost-circulation material reached 7 MPa, the lap anti-shear strength was 0.13 MPa, and the compressive strength was 18.8 MPa.

### Example 8

The lost-circulation slurry was prepared according to the formula of the lost-circulation composition in Example 8 of Table 2.

### (1) Preparation of a Water-In-Oil Emulsion:

4 parts of anionic polyacrylamide with a weight-average molecular weight of 4,000,000 g/mol were initially added into 80 parts of water, stirred and dissolved to obtain a polyacrylamide solution; 1 part of an emulsifier NP-15 was introduced into 100 g of waste diesel oil and stirred and dissolved to obtain an oil phase; the obtained polyacrylamide solution was then slowly added into the oil phase, subjected to stirring and emulsifying at a stirring speed of 9,000 r/min to produce a water-in-oil emulsion;

### (2) Preparation of a Lost-Circulation Slurry:

The water-in-oil emulsion obtained in step (1) was mixed uniformly with other ingredients to obtain a lost-circulation slurry.

The density of the lost-circulation slurry at 25° C. was measured to be 1.05 g/cm³ according to the aforementioned method. The obtained lost-circulation slurry was injected into water at the temperature of 90° C., the time for the lost-circulation slurry to generate a gel was 20s, and the time for reaching the complete curing was 75 min. The formed gel was subjected to water injection and scouring by using a testing device, and the mass retention rate of the gel was calculated at 95.5%. After the gel was completely cured to form a lost-circulation material, the test results indicated that the bearing strength of the lost-circulation material reached 7 MPa, the lap anti-shear strength was 0.12 MPa, and the compressive strength was 19.8 MPa.

### Example 9

The lost-circulation slurry was prepared according to the formula of the lost-circulation composition in Example 9 of Table 2.

### (1) Preparation of a Water-In-Oil Emulsion:

2 parts of anionic polyacrylamide with a weight-average molecular weight of 8,000,000 g/mol were initially added into 60 parts of water, stirred and dissolved to obtain a polyacrylamide solution; 4 parts of an emulsifier OP-15 were introduced into 100 g of waste edible oil and stirred and dissolved to obtain an oil phase; the obtained polyacrylamide solution was then slowly added into the oil phase, subjected to stirring and emulsifying at a stirring speed of 12,000 r/min to produce a water-in-oil emulsion;

### (2) Preparation of a Lost-Circulation Slurry:

The water-in-oil emulsion obtained in step (1) was mixed uniformly with other ingredients to obtain a lost-circulation slurry.

The density of the lost-circulation slurry at 25° C. was measured to be 1.36 g/cm³ according to the aforementioned method. The obtained lost-circulation slurry was injected into water at the temperature of 140° C., the time for the lost-circulation slurry to generate a gel was 10s, and the time for reaching the complete curing was 39 min. The formed gel was subjected to water injection and scouring by using a testing device, and the mass retention rate of the gel was calculated at 93.1%. After the gel was completely cured to form a lost-circulation material, the test results indicated that the bearing strength of the lost-circulation material reached 7 MPa, the lap anti-shear strength was 0.12 MPa, and the compressive strength was 16.8 MPa.

### Example 10

The lost-circulation slurry was prepared according to the formula of the lost-circulation composition in Example 10 of Table 2.

### (1) Preparation of a Water-In-Oil Emulsion:

1 part of anionic polyacrylamide with a weight-average molecular weight of 4,500,000 g/mol was initially added into 80 parts of water, stirred and dissolved to obtain a polyacrylamide solution; 0.1 part of an emulsifier S-80 was introduced into 100 g of waste engine oil and stirred and dissolved to obtain an oil phase; the obtained polyacrylamide solution was then slowly added into the oil phase, subjected to stirring and emulsifying at a stirring speed of 10,000 r/min to produce a water-in-oil emulsion;

### (2) Preparation of a Lost-Circulation Slurry:

The water-in-oil emulsion obtained in step (1) was mixed uniformly with other ingredients to obtain a lost-circulation slurry.

The density of the lost-circulation slurry at 25° C. was measured to be 1.23 g/cm³ according to the aforementioned method. The obtained lost-circulation slurry was injected into water at the temperature of 100° C., the time for the lost-circulation slurry to generate a gel was 40s, and the time for reaching the complete curing was 35 min. The formed gel was subjected to water injection and scouring by using a testing device, and the mass retention rate of the gel was calculated at 97.8%. After the gel was completely cured to form a lost-circulation material, the test results indicated that the bearing strength of the lost-circulation material was 7 MPa, the lap anti-shear strength was 0.11 MPa, and the compressive strength was 17.5 MPa.

### Example 11

The lost-circulation slurry was prepared according to the formula of the lost-circulation composition in Example 11 of Table 2.

### (1) Preparation of a Water-In-Oil Emulsion:

10 parts of anionic polyacrylamide with a weight-average molecular weight of 6,000,000 g/mol was initially added into 70 parts of water, stirred and dissolved to obtain a polyacrylamide solution; 5 parts of an emulsifier T-20 was introduced into 100 g of waste edible oil and stirred and dissolved to obtain an oil phase; the obtained polyacrylamide solution was then slowly added into the oil phase, subjected to stirring and emulsifying at a stirring speed of 9,000 r/min to produce a water-in-oil emulsion;

### (2) Preparation of a Lost-Circulation Slurry:

The water-in-oil emulsion obtained in step (1) was mixed uniformly with other ingredients to obtain a lost-circulation slurry.

The density of the lost-circulation slurry at 25° C. was measured to be 1.78 g/cm³ according to the aforementioned method. The obtained lost-circulation slurry was injected into water at the temperature of 110° C., the time for the lost-circulation slurry to generate a gel was 25s, and the time for reaching the complete curing was 38 min. The formed gel was subjected to water injection and scouring by using a testing device, and the mass retention rate of the gel was calculated at 97%. After the gel was completely cured to form a lost-circulation material, the test results indicated that the bearing strength of the lost-circulation material was 7 MPa, the lap anti-shear strength was 0.14 MPa, and the compressive strength was 17 MPa.

### Example 12

The lost-circulation slurry was prepared according to the method in Example 7. The lost-circulation slurry was prepared according to the formula of the lost-circulation composition in Example 7 of Table 2, except that the silicon cross-linking agent was not added.

The density of the lost-circulation slurry at 25° C. was measured to be 1.05 g/cm³ according to the aforementioned method. The obtained lost-circulation slurry was injected into water at the temperature of 60° C., the time for the lost-circulation slurry to generate a gel was 45s, and the time for reaching the complete curing was 40 min. The formed gel was subjected to water injection and scouring by using a testing device, and the mass retention rate of the gel was calculated at 93%. After the gel was completely cured to form a lost-circulation material, the test results indicated that the bearing strength of the lost-circulation material reached 6.5 MPa, the lap anti-shear strength was 0.1 MPa, and the compressive strength was 15.6 MPa.

### Comparative Example 2

The lost-circulation slurry was prepared according to the method in Example 7, except that polyacrylamide was not added to the water-in-oil emulsion.

Upon testing, the lost-circulation slurry of the comparative example cannot generate a gel.

TABLE 2

| Ingredients | Example 7 | | Example 8 | | Example 9 | | Example 10 | | Example 11 | |
|---|---|---|---|---|---|---|---|---|---|---|
| Water-in-oil | 100 | parts | 100 | parts | 100 | parts | 100 | parts | 100 | parts |
| emulsion | | | | | | | | | | |
| Monomer | 25 parts of | | 5 parts of | | 15 parts of | | 5 parts of | | 20 parts of | |
| represented | acrylamide | | acrylamide | | acrylamide | | acrylamide | | acrylamide | |
| by formula | | | | | | | | | | |
| (I) | | | | | | | | | | |
| Initiator | 0.5 part of | | 2 parts of | | 1 part of | | 5 parts of | | 0.01 part of | |
| | ammonium | | benzoyl | | di-t-butyl | | azobisisobutyronitrile | | lauroyl | |
| | persulfate | | peroxide | | peroxide | | | | peroxide | |
| Allyl-type | 0.3 part of | | 0.3 part of | | 0.3 part of | | 0.3 part of | | 0.5 part of | |
| cross-linking | N,N′-methylene | | ethoxylated | | pentaerythritol | | ethoxylated | | ethoxylated | |
| agent | bisacrylamide, 0.3 | | trimethylolpropane | | triacrylate, 0.3 part | | trimethylolpropane | | trimethylolpropane | |
| | part of glycerol | | triacrylate, 0.3 part | | of ethoxylated | | triacrylate, | | triacrylate, 0.1 part | |
| | triacrylate, 0.3 part | | of ethoxylated | | pentaerythritol | | 0.5 part of | | of pentaerythritol | |
| | of pentaerythritol | | trimethylolpropane | | tetraacrylate, 0.3 | | ethoxylated | | triacrylate, 0.4 part | |
| | tetraacrylate | | triacrylate, 0.3 part | | part of ethoxylated | | trimethylolpropane | | of pentaerythritol | |
| | | | of ethoxylated | | pentaerythritol | | triacrylate, 0.2 part | | tetraacrylate | |
| | | | pentaerythritol | | tetraacrylate | | of ethoxylated | | | |
| | | | tetraacrylate | | | | pentaerythritol | | | |
| | | | | | | | tetraacrylate | | | |
| Organometallic | 3 parts of | | 2.5 parts of | | 1 part of | | 0.5 part of | | 5 parts of | |
| cross-linking agent | aluminum | | chromium | | zirconium | | chromium | | zirconium | |
| | citrate | | lactate | | citrate | | lactate | | citrate | |
| Silicon | 0.2 part of | | 0.2 part of | | 3 parts of | | 7 parts of | | 10 parts of | |
| cross-linking | ethyl | | sodium | | KH570 | | ethyl | | KH570 | |
| agent | silicate | | silicate | | | | silicate | | | |
| Monomer represented | 5 parts of | | 15 parts of | | 10 parts of | | 1 part of | | 10 parts of | |
| by formula (V) | sodium | | sodium | | sodium | | sodium | | sodium | |
| | acrylate | | acrylate | | acrylate | | acrylate | | acrylate | |
| Monomer | 1 part of | | 10 parts of | | 5 parts of | | 1 part of | | 10 parts of | |
| represented | sodium | | sodium | | sodium | | sodium | | sodium | |
| by formula | 2-acrylamide-2-methyl | | 2-acrylamide-2-methyl | | 2-acrylamide-2-methyl | | 2-acrylamide-2-methyl | | 2-acrylamide-2-methyl | |
| (II) | propane | | propane | | propane | | propane | | propane | |
| | sulfonate | | sulfonate | | sulfonate | | sulfonate | | sulfonate | |
| Monomer | 8 parts of | | 3 parts of | | 8 parts of | | 5 parts of | | 1 part of | |
| represented | acryloyloxyethyl | | acryloyloxyethyl | | acryloyloxyethyl | | acryloyloxyethyl | | acryloyloxyethyl | |
| by formula | trimethyl ammonium | | trimethyl ammonium | | trimethyl ammonium | | trimethyl ammonium | | trimethyl ammonium | |
| (VI) | chloride | | chloride | | chloride | | chloride | | chloride | |
| Monomer represented | 1 part of | | 3 parts of | | 3 parts of | | 2 parts of | | 2.5 parts of | |
| by formula (IV) | allyl | | allyl | | allyl | | allyl | | allyl | |
| | nonylphenol | | nonylphenol | | nonylphenol | | nonylphenol | | nonylphenol | |
| | polyoxyethylene | | polyoxyethylene | | polyoxyethylene | | polyoxyethylene | | polyoxyethylene | |
| | ether | | ether | | ether | | ether | | ether | |
| Dopamine | 0.5 | part | 1 | part | 0.5 | part | 0.01 | part | 0.3 | part |

| | | | | | |
|---|---|---|---|---|---|
| Weighting agent | — | — | 50 parts of | 10 parts of | 100 parts of |
| | | | barite | calcium | iron |
| | | | | carbonate | ore powder |

### Example 13

Step 1: preparation of a water non-dispersible material: 20 g of salt-resistant polymer SMPFL-C and 2 g of polyacrylamide having a weight-average molecular weight of 5,000,000 g/mol were uniformly mixed to obtain a water non-dispersible material;

Step 2: preparation of a cross-linking agent: 100 g of sodium silicate, 100 g of zirconium citrate, and 5 g of polyethyleneimine were blended, 90 g of water and 0.2 g of sodium dodecyl benzene sulfonate were further added, and uniformly stirred at 65° C. to obtain a cross-linking agent;

Step 3: 100 g of water, 150 g of a chemical consolidating material SMHD-1, 12 g of the water non-dispersing material obtained in Step 1, 1 g of the cross-linking agent obtained in Step 2, and 1 g of 2-acrylamide-2-methylpropanesulfonic acid polymer were uniformly stirred to obtain a lost-circulation slurry.

The density of the lost-circulation slurry at 25° C. was measured to be 1.65 g/cm³ according to the aforementioned method. Under the airtight condition of 90° C., the time for the lost-circulation slurry to generate a gel was 30 min, and the time for reaching the complete curing was 5.5h. The formed gel was subjected to water injection and scouring by using a testing device, and the mass retention rate of the gel was calculated at 95.2%. After the gel was completely cured to form a lost-circulation material, the test results indicated that the bearing strength of the lost-circulation material reached 7 MPa, the lap anti-shear strength was 0.14 MPa, and the compressive strength was 21.4 MPa.

### Example 14

Step 1: preparation of a water non-dispersible material: 100 g of salt-resistant polymer SMVIS-1 and 2 g of polyacrylamide having a weight-average molecular weight of 10,000,000 g/mol were uniformly mixed to obtain a water non-dispersible material;

Step 2: preparation of a cross-linking agent: 100 g of ethyl orthosilicate, 80 g of zirconium citrate, and 7 g of polyethyleneimine were blended, 60 g of water and 0.5 g of sodium dodecyl benzene sulfonate were further added, and uniformly stirred at 40° C. to obtain a cross-linking agent;

Step 3: 100 g of water, 200 g of a chemical consolidating material SMHD-1, 12 g of the water non-dispersing material obtained in Step 1, 3 g of the cross-linking agent obtained in Step 2, and 4 g of hydroxycarboxylic acid polymer were uniformly stirred to obtain a lost-circulation slurry.

The density of the lost-circulation slurry at 25° C. was measured to be 1.72 g/cm³ according to the aforementioned method. Under the airtight condition of 120° C., the time for the lost-circulation slurry to generate a gel was 20 min, and the time for reaching the complete curing was 4.5h. The formed gel was subjected to water injection and scouring by using a testing device, and the mass retention rate of the gel was calculated at 94.8%. After the gel was completely cured to form a lost-circulation material, the test results indicated that the bearing strength of the lost-circulation material reached 7 MPa, the lap anti-shear strength was 0.13 MPa, and the compressive strength was 23.8 MPa.

### Example 15

Step 1: preparation of a water non-dispersible material: 20 g of salt-resistant polymer SMHV-C and 4 g of nonionic polyacrylamide having a weight-average molecular weight of 14,000,000 g/mol were uniformly mixed to obtain a water non-dispersible material;

Step 2: preparation of a cross-linking agent: 100 g of KH560, 150 g of chromium lactate, and 3 g of polyethyleneimine were blended, 50 g of water and 1 g of sodium dodecyl benzene sulfonate were further added, and uniformly stirred at 50° C. to obtain a cross-linking agent;

Step 3: 100 g of water, 180 g of chemical consolidating material SMHD-2, 15 g of the water non-dispersing material obtained in Step 1, 2.5 g of the cross-linking agent obtained in Step 2, 3.5 g of hydroxycarboxylic acid polymer and 30 g of barite were uniformly stirred to obtain a lost-circulation slurry.

The density of the lost-circulation slurry at 25° C. was measured to be 1.69 g/cm³ according to the aforementioned method. Under the airtight condition of 150° C., the time for the lost-circulation slurry to generate a gel was 20 min, and the time for reaching the complete curing was 3.2h. The formed gel was subjected to water injection and scouring by using a testing device, and the mass retention rate of the gel was calculated at 93.7%. After the gel was completely cured to form a lost-circulation material, the test results indicated that the bearing strength of the lost-circulation material reached 7 MPa, the lap anti-shear strength was 0.12 MPa, and the compressive strength was 22.7 MPa.

### Example 16

A lost-circulation slurry was prepared according to the method in Example 13, except that in Step 3, 100 g of water, 150 g of a chemical consolidating material SMHD-1, 10 g of a water non-dispersible material, and 0.1 g of a cross-linking agent were uniformly stirred to obtain a lost-circulation slurry.

The density of the lost-circulation slurry at 25° C. was measured to be 1.5 g/cm³ according to the aforementioned method. Under the airtight condition of 80° C., the time for the lost-circulation slurry to generate a gel was 40 min, and the time for reaching the complete curing was 6 h. The formed gel was subjected to water injection and scouring by using a testing device, and the mass retention rate of the gel was calculated at 91.3%. After the gel was completely cured to form a lost-circulation material, the test results indicated that the bearing strength of the lost-circulation material reached 7 MPa, the lap anti-shear strength was 0.10 MPa, and the compressive strength was 17.5 MPa.

### Example 17

A lost-circulation slurry was prepared according to the method in Example 13, except that in Step 1, 20 g of salt-resistant polymer SMPFL-C and 6 g of polyacrylamide having a weight-average molecular weight of 5,000,000 g/mol were uniformly mixed to obtain a water non-dispersible material; and in Step 2, 100 g of sodium silicate, 10 g of zirconium citrate and 10 g of polyethyleneimine were blended, 90 g of water and 0.2 g of sodium dodecyl benzene sulfonate were further added, the materials were uniformly stirred at 65° C. to obtain a cross-linking agent.

The density of the lost-circulation slurry at 25° C. was measured to be 1.65 g/cm³ according to the aforementioned method. Under the airtight condition of 100° C., the time for the lost-circulation slurry to generate a gel was 25 min, and the time for reaching the complete curing was 5 h. The formed gel was subjected to water injection and scouring by using a testing device, and the mass retention rate of the gel was calculated at 94.1%. After the gel was completely cured to form a lost-circulation material, the test results indicated that the bearing strength of the lost-circulation material reached 7 MPa, the lap anti-shear strength was 0.11 MPa, and the compressive strength was 20.4 MPa.

### Example 18

A lost-circulation slurry was prepared according to the method in Example 13, except that in Step 2, 100 g of sodium silicate was not added; that is, Step 2: preparation of a cross-linking agent: 100 g of zirconium citrate and 5 g of polyethyleneimine were blended, 90 g of water and 0.2 g of sodium dodecyl benzene sulfonate were further added, and uniformly stirred at 65° C. to obtain a cross-linking agent.

The density of the lost-circulation slurry at 25° C. was measured to be 1.65 g/cm³ according to the aforementioned method. Under the airtight condition of 90° C., the time for the lost-circulation slurry to generate a gel was 30 min, and the time for reaching the complete curing was 5.3h. The formed gel was subjected to water injection and scouring by using a testing device, and the mass retention rate of the gel was calculated at 92.3%. After the gel was completely cured to form a lost-circulation material, the test results indicated that the bearing strength of the lost-circulation material reached 7 MPa, the lap anti-shear strength was 0.11 MPa, and the compressive strength was 19.5 MPa.

### Example 19

A lost-circulation slurry was prepared according to the method in Example 13, except that the test conditions were modified from the airtight condition of 90° C. to the airtight condition of 180° C., the specific method was as follows:

The density of the lost-circulation slurry at 25° C. was measured to be 1.65 g/cm³ according to the aforementioned method. Under the airtight condition of 180° C., the time for the lost-circulation slurry to generate a gel was 10 min, and the time for reaching the complete curing was 0.5h. The formed gel was subjected to water injection and scouring by using a testing device, and the mass retention rate of the gel was calculated at 96.5%. After the gel was completely cured to form a lost-circulation material, the test results indicated that the bearing strength of the lost-circulation material reached 7 MPa, the lap anti-shear strength was 0.12 MPa, and the compressive strength was 18.9 MPa.

### Comparative Example 3

A lost-circulation slurry was prepared according to the method in Example 13, except that the chemical consolidating material SMHD-1 was not added in Step 3, i.e., the added amount of the chemical consolidating material SMHD-1 was 0. Under the souring of water flow, the gel formed by the lost-circulation slurry cannot be cured to form a plug, thus the lost-circulation and pressure-bearing effects cannot be achieved.

### Comparative Example 4

A lost-circulation slurry was prepared according to the method in Example 13, except that the method did not include Step 1, and a water non-dispersible material was not added in Step 3, i.e., the added amount of the water non-dispersible material was 0. The gel formed by the lost-circulation slurry was easily diluted by water and can be easily scattered by water under the condition of scouring with the flowing water, the gel cannot be cured to form a plug, thus the lost-circulation and pressure-bearing effects cannot be achieved.

As can be seen from Examples 1-19, the gel formed by the lost-circulation slurry prepared with the lost-circulation composition in the technical scheme of the invention has a property of water dilution resistance, the gel can reside in a flowing water-bearing lost-circulation formation after entering a flowing water layer, and can be cured after a time period under the temperature and pressure environment of the formation to form a cured material with a high compressive strength. The compressive strength of the cured material is 16 MPa or more, the mass retention rate is higher than 90%, and the bearing strength can reach 7 MPa, thereby solving the difficult problem of lost circulation of the flowing water-bearing formation.

As indicated by the results of the aforementioned Examples and Comparative Examples, the lost-circulation materials in the Examples of the invention have significant advantages in terms of water dilution resistance, high-temperature resistance, and other aspects, and have higher mass retention rate and compressive strength when applied in the flowing water-bearing formation, and are suitable for a water-bearing formation having a temperature of not higher than 180° C., especially a flowing water-bearing formation.

The above content describes in detail the preferred embodiments of the invention, but the invention is not limited thereto. A variety of simple modifications can be made in regard to the technical solutions of the invention within the scope of the technical concept of the invention, including a combination of individual technical features in any other suitable manner, such simple modifications and combinations thereof shall also be regarded as the content disclosed by the invention, each of them falls into the protection scope of the invention.

1. A lost-circulation composition, characterized in that the lost-circulation composition can be cross-linked to form a gel before or during being injected into the formation, and the gel can be cured at the lost-circulation formation to form a lost-circulation material, wherein the mass retention rate of the gel when scouring at 50-180° C. for 30 min at a water flow rate of 10 m/min is 90% or more; and the lap anti-shear strength of the lost-circulation material is within the range of 0.1-0.14 MPa.

2. The lost-circulation composition according to claim 1, wherein the bearing strength of the lost-circulation material is not less than 7 MPa;
and/or, the compressive strength of the lost-circulation material is not less than 16 MPa;
and/or, the lost-circulation formation is a water-bearing formation;
and/or, the temperature of the lost-circulation formation is within the range of 50-180° C.

3. The lost-circulation composition according to claim 2, wherein the compressive strength of the lost-circulation material is within the range of 18-25 MPa;
and/or the lost-circulation formation is a flowing water-bearing formation.

4-19. (canceled)

20. A method of plugging an oil well, characterized in that the method comprises: injecting the lost-circulation composition according to claim 1 directly into cracks in the oil well formation such that the lost-circulation composition forms a gel during the process of injection into the formation, or injecting a gel into cracks in the oil well formation after the lost-circulation composition forms the gel, which is cured at the lost-circulation formation under the formation conditions to form a lost-circulation material; wherein the mass retention rate of the gel when scouring at 50-180° C. for 30 min at a water flow rate of 10 m/min is 90% or more; and the lap anti-shear strength of the lost-circulation material is within the range of 0.1-0.14 MPa

21. The lost-circulation composition according to claim 1, wherein the lost-circulation composition comprises the following ingredients: a cross-linkable polymer, a cross-linking agent, an enhancer, and a solvent; wherein the cross-linking agent contains a metal cross-linking agent and/or an allyl-type cross-linking agent, and the enhancer is an enhancer I and/or an enhancer II; the enhancer I comprise a monomer represented by formula (I), dopamine, and an initiator; 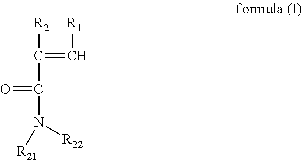
Wherein R₁, R₂, R₂₁ and R₂₂ are each independently hydrogen or a straight or branched chain alkyl group of C₁-C₁₀;
the enhancer II comprises a consolidating material and a set retarder, the consolidating material is a material that can be hydrated and cured when contacting with water, the consolidating material has a compressive strength of more than 10 MPa, and an expansion rate within the range of 0.5-1.5%.

22. The lost-circulation composition according to claim 21, wherein the cross-linkable polymer is polyacrylamide and/or a polyacrylamide derivative, and the solvent is water; the lost-circulation composition comprises the following ingredients in parts by weight: 0.01-8 parts of a cross-linkable polymer, 0.01-8 parts of a metal cross-linking agent, 0.01-0.9 part of an allyl-type cross-linking agent, 3-30 parts of a monomer represented by formula (I), 0.01-3 parts of dopamine, 0.01-8 parts of an initiator, and 100 parts of water.

23. The lost-circulation composition according to claim 22, wherein the cross-linkable polymer has a weight-average molecular weight within the range of 2,500,000 to 18,000,000 g/mol; and/or, the metal cross-linking agent is at least one selected from the group consisting of a zirconium cross-linking agent, a chromium cross-linking agent, and an aluminum cross-linking agent;
and/or, the allyl-type cross-linking agent is at least one selected from the group consisting of N,N′-methylene bisacrylamide, glycerol triacrylate, ethoxylated trimethylolpropane triacrylate, pentaerythritol triacrylate, pentaerythritol tetraacrylate, and ethoxylated pentaerythritol tetraacrylate;
and/or, the enhancer I further comprises at least one of a monomer represented by formula (II), a monomer represented by formula (III), a monomer represented by formula (IV), a monomer represented by formula (V), and a monomer represented by formula (VI): 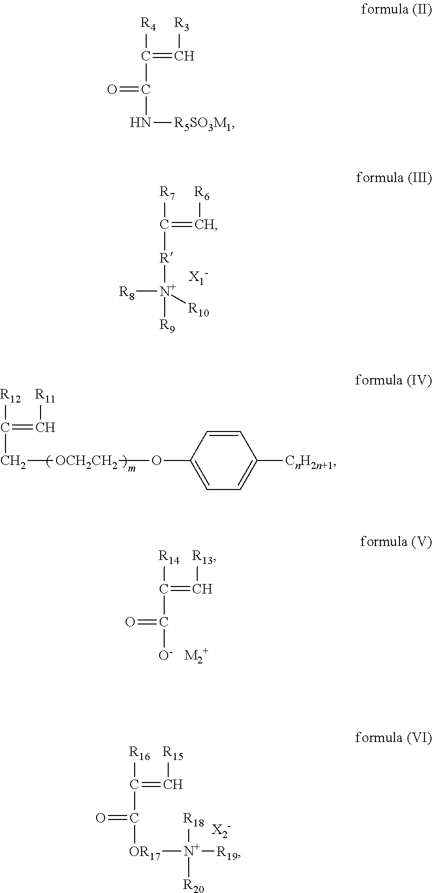
wherein R₃, R₄, R₆, R₇, R₁₁, R₁₂, R₁₃, R₁₄, R₁₅, R₁₆, R₁₈, R₁₉ and R₂₀ are each independently hydrogen or a straight or branched chain alkyl group of C₁-C₁₀; R₅ and R₁₇ are each independently a straight or branched chain alkylene group of C₁-C₂₀; one of R₈, R₉ and R₁₀ is a straight or branched chain alkyl group of C₁-C₂₀, the other two are each independently hydrogen, or a straight or branched chain alkyl group of C₁-C₁₀, and R′ is a straight or branched chain alkylene group of C₁-C₁₀; Mi and M₂ are each independently H, Na, Li, or K; X₁ and X₂ are each independently selected from Cl, Br, or I; m is any integer within the range of 4-20, and n is an integer within the range of 3-10.

24. The lost-circulation composition according to claim 23, wherein the cross-linkable polymer has a weight-average molecular weight within the range of 3,000,000 to 16,000,000 g/mol;
and/or, the monomer represented by formula (II) is used in an amount of 0.2-20 parts by weight based on 100 parts by weight of water;
and/or, the monomer represented by formula (III) is used in an amount of 0.5-20 parts by weight based on 100 parts by weight of water;
and/or, the monomer represented by formula (IV) is used in an amount of 0.2-5 parts by weight based on 100 parts by weight of water;
and/or, the monomer represented by formula (V) is used in an amount of 0.5-20 parts by weight based on 100 parts by weight of water;
and/or, the monomer represented by formula (VI) is used in an amount of 0.5-10 parts by weight based on 100 parts by weight of water.

25. The lost-circulation composition according to claim 24, wherein the monomer represented by formula (II) is used in an amount of 2-15 parts by weight based on 100 parts by weight of water;
and/or, the monomer represented by formula (III) is used in an amount of 1-15 parts by weight based on 100 parts by weight of water;
and/or, the monomer represented by formula (IV) is used in an amount of 0.5-4 parts by weight based on 100 parts by weight of water;
and/or, the monomer represented by formula (V) is used in an amount of 1-15 parts by weight based on 100 parts by weight of water;
and/or, the monomer represented by formula (VI) is used in an amount of 1-8 parts by weight based on 100 parts by weight of water.

26. The lost-circulation composition according to claim 21, wherein the cross-linkable polymer is polyacrylamide and/or a polyacrylamide derivative, the cross-linkable polymer is present in the form of a water-in-oil emulsion comprising the cross-linkable polymer, oil, water, and an emulsifier.

27. The lost-circulation composition according to claim 26, wherein the lost-circulation composition comprises the following ingredients in parts by weight: 100 parts of water-in-oil emulsion, 0.01-8 parts of a cross-linking agent, 3-30 parts of the monomer represented by formula (I), 0.01-2 parts of dopamine, and 0.01-8 parts of an initiator;
and/or, the mass ratio of the cross-linkable polymer to the oil, water, and the emulsifier is (0.5-15):100:(50-100):(0.05-10);
and/or, the oil is at least one selected from the group consisting of waste white oil, waste diesel oil, waste engine oil, and waste edible oil;
and/or, the cross-linkable polymer is anionic polyacrylamide, and the anionic polyacrylamide has a weight-average molecular weight within the range of 2,500,000-10,000,000 g/mol;
and/or, the emulsifier is at least one selected from the group consisting of octylphenol polyoxyethylene ether-10, octylphenol polyoxyethylene ether-15, nonylphenol polyoxyethylene ether-10, nonylphenol polyoxyethylene ether-15, polyoxyethylene sorbitan monolaurate, polyoxyethylene sorbitan monostearate, sorbitan monooleate, sorbitan trioleate, and sodium dodecylbenzene sulfonate;
and/or, the enhancer I further comprises at least one of a monomer represented by formula (II), a monomer represented by formula (III), a monomer represented by formula (IV), a monomer represented by formula (V), and a monomer represented by formula (VI): 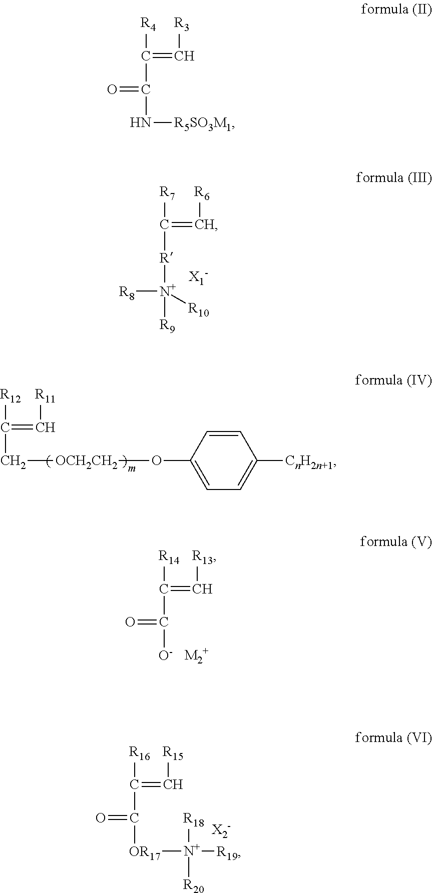
wherein R₃, R₄, R₆, R₇, R₁, R₁₂, R₁₃, R₁₄, R₁₅, R₁₆, R₁₈, R₁₉ and R₂₀ are each independently hydrogen or a straight or branched chain alkyl group of C₁-C₁₀; R₅ and R₁₇ are each independently a straight or branched chain alkylene group of C₁-C₂₀; one of R₈, R₉ and R₁₀ is a straight or branched chain alkyl group of C₁-C₂₀, the other two are each independently hydrogen or a straight or branched chain alkyl group of C₁-C₁₀, and R′ is a straight or branched chain alkylene group of C₁-C₁₀; M₁ and M₂ are each independently H, Na, Li, or K; X₁ and X₂ are each independently selected from Cl, Br, or I; m is any integer within the range of 4-20, and n is any integer within the range of 3-10.

28. The lost-circulation composition according to claim 27, wherein the mass ratio of the cross-linkable polymer to the oil, water, and the emulsifier is (1-10): 100:(60-90):(0.1-5);
and/or, the anionic polyacrylamide has a weight-average molecular weight within the range of 3,000,000-8,000,000 g/mol;
and/or, the monomer represented by formula (II) is used in an amount of 0.2-20 parts by weight based on 100 parts by weight of the water-in-oil emulsion;
and/or, the monomer represented by formula (III) is used in an amount of 0.5-20 parts by weight based on 100 parts by weight of the water-in-oil emulsion;
and/or, the monomer represented by formula (IV) is used in an amount of 0.2-5 parts by weight based on 100 parts by weight of the water-in-oil emulsion;
and/or, the monomer represented by formula (V) is used in an amount of 0.5-20 parts by weight based on 100 parts by weight of the water-in-oil emulsion;
and/or, the monomer represented by formula (VI) is present in an amount of 0.5-10 parts by weight based on 100 parts by weight of the water-in-oil emulsion;
and/or, the cross-linking agent is a mixture of an allyl-type cross-linking agent and an organometallic cross-linking agent, wherein the mass ratio of the allyl-type cross-linking agent to the organometallic cross-linking agent is 1:(0.3-8).

29. The lost-circulation composition according to claim 28, wherein the monomer represented by formula (II) is used in an amount of 2-15 parts by weight based on 100 parts by weight of the water-in-oil emulsion;
and/or, the monomer represented by formula (III) is used in an amount of 1-15 parts by weight based on 100 parts by weight of the water-in-oil emulsion;
and/or, the monomer represented by formula (IV) is used in an amount of 0.5-4 parts by weight based on 100 parts by weight of the water-in-oil emulsion;
and/or, the monomer represented by formula (V) is used in an amount of 1-15 parts by weight based on 100 parts by weight of the water-in-oil emulsion;
and/or, the monomer represented by formula (VI) is present in an amount of 1-8 parts by weight based on 100 parts by weight of the water-in-oil emulsion;
and/or, the mass ratio of the allyl-type cross-linking agent to the organometallic cross-linking agent is 1:(0.5-5);
and/or, the organometallic cross-linking agent is at least one selected from the group consisting of an organozirconium cross-linking agent, an organochromium cross-linking agent, and an organoaluminium cross-linking agent.

30. The lost-circulation composition according to claim 21, wherein the cross-linking agent further comprises a silicon cross-linking agent;
and/or, the initiator is at least one selected from the group consisting of potassium persulfate, ammonium persulfate, sodium persulfate, benzoyl peroxide, azobisisobutyramidine hydrochloride, di-t-butyl peroxide, lauroyl peroxide, azobisisobutyronitrile, and cumene hydroperoxide.

31. The lost-circulation composition according to claim 30, wherein the silicon cross-linking agent is at least one selected from the group consisting of sodium silicate, ethyl silicate, and γ-methacryloxy propyl trimethoxysilane;
and/or, the mass ratio of the allyl-type cross-linking agent to the metal cross-linking agent and the silicon cross-linking agent is 1:(0.3-8):(0.1-12);
and/or, the initiator is at least one selected from the group consisting of potassium persulfate, ammonium persulfate, sodium persulfate, benzoyl peroxide, azobisisobutyramidine hydrochloride, di-t-butyl peroxide, lauroyl peroxide, azobisisobutyronitrile, and cumene hydroperoxide.

32. The lost-circulation composition according to claim 31, wherein the mass ratio of the allyl-type cross-linking agent to the metal cross-linking agent and the silicon cross-linking agent is 1:(0.5-5):(0.2-10).

33. The lost-circulation composition according to claim 21, wherein the lost-circulation composition further comprises a salt-resistant polymer, the salt-resistant polymer, and the cross-linkable polymer form a water non-dispersible material; the lost-circulation composition comprises the following ingredients in parts by weight: 10-15 parts of a water non-dispersible material, 0.1-4 parts of a cross-linking agent, 50-200 parts of a consolidating material, 0.5-5 parts of a set retarder and 100 parts of water;
and/or, the density of the lost-circulation composition at 25° C. after mixing is within the range of 1-2 g/cm³.

34. The lost-circulation composition according to claim 33, wherein the mass ratio of the salt-resistant polymer to the cross-linkable polymer is 10:(0.5-3);
and/or, the cross-linkable polymer is polyacrylamide and/or a polyacrylamide derivative;
and/or, the cross-linkable polymer has a weight-average molecular weight within the range of 2,000,000-14,000,000 g/mol;
and/or, the set retarder is selected from 2-acrylamide-2-methylpropanesulfonic acid polymer and/or hydroxycarboxylic acid polymer;
and/or, the density of the lost-circulation composition at 25° C. after mixing is within the range of 1.2-1.65 g/cm³.

35. A lost-circulation material, is characterized in that the lost-circulation material is obtained by curing the lost-circulation composition according to claim 1.

36. The lost-circulation material according to claim 35, wherein the curing temperature is within the range of 50-180° C.;
and/or the lost-circulation material has a compressive strength within the range of 15-25 MPa.
